(19) United States
(12) Patent Application Publication
(10) Pub. No.: US 2022/0203363 A1
(43) Pub. Date: Jun. 30, 2022

(54) MULTIMODAL TEST CARDS

(71) Applicant: Fluxergy Inc., Irvine, CA (US)

(72) Inventors: Eric Charrault, Irvine, CA (US); Sepehr Maktabi, Irvine, CA (US); Roy Heltsley, Irvine, CA (US); Steve Lee, Foothill Ranch, CA (US); Farzad Izadi Kharazi, Rancho Santa Margarita, CA (US); Ryan Revilla, Costa Mesa, CA (US); Tej Patel, Carlsbad, CA (US); Jonathan Tu, Rolling Hills, CA (US)

(21) Appl. No.: 17/566,798

(22) Filed: Dec. 31, 2021

Related U.S. Application Data
(60) Provisional application No. 63/132,618, filed on Dec. 31, 2020.

(51) Int. Cl. B01L 3/00; B01L 7/00

(52) U.S. Cl. CPC B01L 3/502715; B01L 7/52; B01L 2300/0819; B01L 2200/16; B01L 2300/1827; B01L 2300/0887; B01L 2300/0864; B01L 2300/069; B01L 2300/0816; B01L 2300/087

(57) ABSTRACT

Described herein are multimodal test cards. The test cards include a shared architecture with interchangeable test zones. The test cards are particularly useful for diagnostic testing.

### CROSS-REFERENCE TO RELATED APPLICATIONS

This application claims priority to U.S. Provisional Application Ser. No. 63/132,618, filed on Dec. 31, 2020, the content of which is hereby incorporated by reference in its entirety.

### FIELD OF THE DISCLOSURE

Described herein are multimodal test cards. The test cards include a shared architecture with interchangeable test zones. The test cards are particularly useful for diagnostic testing.

### BACKGROUND OF THE DISCLOSURE

Conventional point-of-care (POC) in vitro diagnostics test (IVDT) platforms typically only perform one test modality. Some POC diagnostics test platforms can perform a small number of different tests, but not at one time. Other POC diagnostics test platforms can perform only limited different tests at one time. Overall, testing capabilities of conventional POC diagnostic test platforms are limited by the time and space requirements for multiple diagnostic tests. This often results in limited diagnostic information and negative patient outcomes.

In a clinical setting, some test results from conventional POC platforms require a subsequent confirmation or reflex test before a diagnosis or clinical outcome is decided. These confirmation or reflex tests can be of a different modality than the initial POC test. In other situations, a combination of tests is required to determine a diagnosis, clinical outcome, or conclusive result. Both scenarios require managing multiple conventional POC platforms or testing services from centralized laboratories. As a result, total cost of diagnosis and time to result is greater than that attributed by an individual, conventional POC test.

### BRIEF DESCRIPTION OF THE DISCLOSURE

In one embodiment, the present disclosure is directed to a microfluidic chip. The microfluidic chip comprises at least one input port fluidically connected to at least two test zones by at least one microfluidic guide, wherein the at least two test zones are configured to perform at least two different tests.

In one embodiment, the present disclosure is directed to a test card. The test card comprises a microfluidic chip comprising at least one input port fluidically connected to at least two test zones by at least one microfluidic guide, wherein the at least two test zones are configured to perform at least two different tests; and a chip carrier coupled to the microfluidic chip.

In yet another embodiment, the present disclosure is directed to a method of using a test card. The method comprises (i) receiving, using a test card, a sample from a subject, the test card including a chip carrier coupled to a microfluidic chip, the microfluidic chip including at least one input port fluidically connected to at least two test zones by at least one microfluidic guide, wherein the at least two test zones are configured to perform at least two different tests; and (ii) testing the sample using the at least two test zones of the test card.

### BRIEF DESCRIPTION OF THE DRAWINGS

The following figures are examples of test cards and components of test cards in accordance with the present disclosure and are not to be construed as limiting.

FIG. 1 is an illustrative depiction of a generalized structure of a test card in accordance with the present disclosure. The test card includes standardized regions for a testing device interface, an optical measurement zone, a sample processing/rehydration zone, and a loading port zone.

FIG. 2 is an illustrative depiction of one embodiment of a test card configured for PCR testing and LFA testing in accordance with the present disclosure. The test card includes a unique inlet port for each testing mode. The test card includes a single LFA strip as well as multiple PCR wells arranged in series.

FIG. 3 is an illustrative depiction of one embodiment of a test card configured for PCR testing and LFA testing in accordance with the present disclosure. The test card includes a unique inlet port for each individual test. The test card includes a single LFA strip as well as multiple PCR wells arranged in parallel.

FIG. 4 is an illustrative depiction of one embodiment of a test card configured for PCR testing and LFA testing in accordance with the present disclosure. The test card includes a unique inlet port for each testing mode. The test card includes a single LFA strip as well as a single lyophilized bead before multiple PCR wells arranged in series.

FIG. 5 is an illustrative depiction of one embodiment of a test card configured for PCR testing and LFA testing in accordance with the present disclosure. The test card includes a single inlet port for all tests. The test card includes a single LFA strip, a lyophilized bead before each individual PCR well, and multiple PCR wells arranged in parallel.

FIG. 6 is an illustrative depiction of one embodiment of a test card configured for PCR testing and LFA testing in accordance with the present disclosure. The test card includes a unique inlet port for each individual test. The test card includes a single LFA strip, a lyophilized bead before each individual PCR well, and multiple PCR wells arranged in parallel.

FIG. 7 is an illustrative depiction of one embodiment of a heated loading port located on the bottom of a test card configured for diagnostic testing in accordance with the present disclosure. The heated loading port is heated by a resistive heater located between two electrodes.

FIG. 8 is an illustrative depiction of one embodiment of a heated rehydration port located on the bottom of a test card configured for diagnostic testing in accordance with the present disclosure. The heated rehydration port is heated by a resistive heater located between two electrodes.

FIG. 9 is an illustrative depiction of one embodiment of a heated rehydration port and a heated loading port located on the bottom of a test card configured for diagnostic testing in accordance with the present disclosure. The heated hydration port and the heated loading port are each individually heated by a resistive heater located between two electrodes.

FIG. 10 is an illustrative depiction of one embodiment of a test card configured for PCR testing and cytometry testing in accordance with the present disclosure. The test card includes a unique inlet port for each testing mode. The test card includes a single cytometry well as well as multiple PCR wells arranged in series.

FIG. 11 is an illustrative depiction of one embodiment of a test card configured for PCR testing and assay testing in accordance with the present disclosure. The test card includes a unique inlet port for each testing mode. The test card includes multiple PCR wells arranged in series as well as multiple assay pads arranged in series.

FIG. 12 is an illustrative depiction of one embodiment of a test card configured for LFA testing and assay testing in accordance with the present disclosure. The test card includes a unique inlet port for each testing mode. The test card includes a single LFA strip as well as multiple assay pads arranged in series.

FIG. 13 is an illustrative depiction of one embodiment of a test card configured for turbidity testing and PCR testing in accordance with the present disclosure. The test card includes a unique inlet port for each testing mode. The test card includes a single turbidity measurement channel as well as multiple PCR wells arranged in series.

FIG. 14 is an illustrative depiction of one embodiment of a test card configured for turbidity testing and LFA testing in accordance with the present disclosure. The test card includes a unique inlet port for each individual test. The test card includes a single turbidity measurement channel as well as a single LFA strip.

FIG. 15 is an illustrative depiction of one embodiment of a test card configured for ion testing and PCR testing in accordance with the present disclosure. The test card includes a unique inlet port for each testing mode. The test card includes a well containing electrode as well as multiple PCR wells arranged in series.

FIG. 16 is an illustrative depiction of one embodiment of a test card configured for ion testing and PCR testing in accordance with the present disclosure. The test card includes a single inlet port for all tests. The test card includes multiple PCR wells arranged in series. Each individual PCR well includes an electrode for ion testing.

FIG. 17 is an illustrative depiction of one embodiment of a test card configured for viscosity testing and cytometry testing in accordance with the present disclosure. The test card includes a unique inlet port for each individual test. The test card includes a cytometry well as well as a viscosity measurement channel.

FIG. 18 is an illustrative depiction of one embodiment of a test card configured for LFA testing and PCR testing in accordance with the present disclosure. The test card includes a unique inlet port for each testing mode. The test card includes multiple LFA strips as well as multiple PCR wells arranged in series.

FIG. 19 is an illustrative depiction of one embodiment of a test card configured for LFA testing and PCR testing in accordance with the present disclosure. The test card includes multiple inlet ports. The test card includes an independent LFA strip as well as multiple PCR wells and a PCR dependent LFA strip arranged in series.

FIG. 20 is an illustrative depiction of one embodiment of a test card configured for immunochemistry testing and PCR testing in accordance with the present disclosure. The test card includes a unique inlet port for each testing mode. It includes multiple immunochemistry wells as well as multiple PCR wells arranged in series. The test card includes a lyophilized bead before the PCR wells.

FIG. 21 is an illustrative depiction of one embodiment of a test card configured for immunochemistry testing and PCR testing in accordance with the present disclosure. The test card includes a unique inlet port for each testing mode. It includes multiple immunochemistry wells as well as multiple PCR wells arranged in series. The test card includes a lyophilized bead before the PCR wells and a lyophilized bead before the immunochemistry wells.

FIG. 22 is an illustrative depiction of one embodiment of a chip carrier in accordance with the present disclosure. The chip carrier is configured for a microfluidic chip configured for LFA testing and PCR testing.

FIG. 23 is an illustrative depiction of one embodiment of a chip carrier in accordance with the present disclosure. The chip carrier is configured for a microfluidic chip configured for PCR testing.

FIG. 24 is an illustrative depiction of one embodiment of a rehydration port in accordance with the present disclosure. The rehydration port includes air vents.

FIG. 25 is an illustrative depiction of one embodiment of a test card in accordance with the present disclosure. The test card is shown in an expanded view with the components separated. The loading port cap, dielectric layer, cover layer, and channel mask are not shown.

FIG. 26 is an illustrative depiction of one embodiment of a test card in accordance with the present disclosure. The test card is shown in an expanded view with the components separated. The loading port cap is not shown. It is configured for PCR testing.

FIG. 27 is an illustrative depiction of one embodiment of a test card in accordance with the present disclosure. The test card is shown in an expanded view with the components separated. The loading port cap is not shown. It is configured for PCR and LFA testing.

FIG. 28 is an illustrative depiction of one embodiment of a chip carrier in accordance with the present disclosure. The chip carrier is configured for a microfluidic chip configured for LFA testing and PCR testing.

FIG. 29 is an illustrative depiction of one embodiment of an assembled test card in accordance with the present disclosure. The test card is configured for PCR testing.

FIG. 30 is an illustrative depiction of one embodiment of an assembled test card in accordance with the present disclosure. The test card is configured for PCR and LFA testing with multiple chips.

FIG. 31 is an illustrative depiction of one embodiment of a chip carrier in accordance with the present disclosure. The chip carrier is configured for a microfluidic chip configured for LFA testing.

FIG. 32 is an illustrative depiction of one embodiment of a rehydration port in accordance with the present disclosure. The rehydration port includes air vents.

FIG. 33 is an illustrative depiction of one embodiment of a test card in accordance with the present disclosure. The test card is shown in an expanded view with the components separated. It is configured for PCR testing.

### DETAILED DESCRIPTION OF THE DISCLOSURE

Described herein are multimodal test cards that can be used for singleplex and multiplex diagnostic analyses. The test cards include a shared architecture and interchangeable test zones. The shared architecture includes standardized fluidic and electrical components. These standardized components allow a single interface for diagnostic interrogation, while also permitting customized diagnostic analyses. The test cards are capable of rapid POC detection and allow for improved medical outcomes.

The test cards can be analyzed with a portable testing device. This combination consolidates a wide variety of possible diagnostic tests within a single platform.

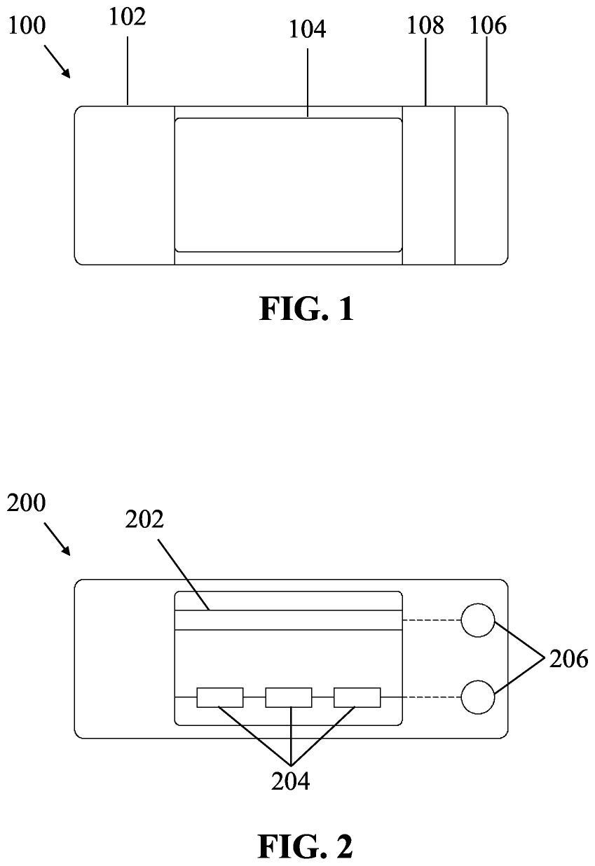

A generalized multimodal test card 100 is shown in FIG. 1. The test card 100 is divided into standardized zones to provide a framework for multimode test cards. The test card 100 includes standardized regions that are pre-allocated for a testing device interface 102, an optical measurement zone 104, a sample processing/rehydration zone 108, and a loading port zone 106. The optical measurement zone 104 is specifically sized to match the viewable area of the optical system of the device used for analysis. The testing device interface zone 102 contains features for connecting to device electronics, pneumatic and fluid actuating systems, and mechanical features for locating the test card within the analysis device. Mechanical compatibility of the test card with the device may extend beyond this region. For example, portions of the test card that are inserted into the device must be shaped so as to fit within the receptacle of the device. In some embodiments, all portions of the test card except the loading port zone 106 are configured to be insertable into the device used for analysis.

The multimodal test card is a highly modular device that may comprise numerous different components. These components include, but are not limited to, carriers, microfluidic chips, substrates, reagents, components configured for interfacing, and combinations thereof.

In some embodiments, the multimodal test card comprises a carrier selected from the group consisting of a single part carrier, a multipart carrier, a multipart carrier comprising a base and bottom housing, a multipart carrier comprising a base and top housing, and combinations thereof. In some embodiments, the housing accommodates microfluidic chips and/or substrates.

In some embodiments, the multimodal test card comprises a microfluidic channel. The microfluidic channel may contain enclosed or open-face microfluidic channels with various designs. The microfluidic channel may contain cavities and/or slots for placement of insert substrates. In some embodiments, the multimodal test card comprises a full chip microfluidic chip, a partial chip microfluidic chip, a partial chip microfluidic chip that extends over half or less of the multimodal test card, and combinations thereof.

In some embodiments, the multimodal test card comprises a substrate. Generally, the substrate may carry solid phase reagents and may be placed in the chip or on the carrier. In some embodiments, the multimodal test card comprises a substrate selected from the group consisting of absorbent strips, absorbent pads, paper, inserts, hydrogels, and combinations thereof.

In some embodiments, the multimodal test card comprises a reagent. Generally, solid phase reagents, such as lyophilized beads and coatings, may be placed either on the chip, the carrier, and/or on one or several substrates. In some embodiments, the multimodal test card comprises a reagent selected from the group consisting of a liquid phase, a liquid phase to be mixed ex-situ with a specimen, a liquid phase in the chip or carrier, lyophilized beads and/or pellets, lyophilized coatings, dry thin film coatings, dry thin film coatings on the chip or on the substrate, and combinations thereof.

In some embodiments, the multimodal test card comprises an interfaceable component. Generally, the interfaceable component is configured to interface with the testing device, process the sample, and/or perform sensing. In some embodiments, the multimodal test card comprises an interfaceable component selected from the group consisting of resistive heaters, sensing electrodes, electrical connectors, electrical connectors that interface with the testing device, pneumatic ports, pneumatic ports that interface with the testing device, and combinations thereof.

A multimodal test card 200 configured for PCR and LFA is shown in FIG. 2. It includes a channel layer with multiple PCR reaction wells 204 and a cavity that accommodates a LFA strip 202. It is configured to perform both PCR and LFA tests. It includes two loading ports 206 to feed both the LFA strip 202 and the PCR wells 204. The PCR sample is loaded into a series of PCR wells (e.g., 3) 204 with the same target.

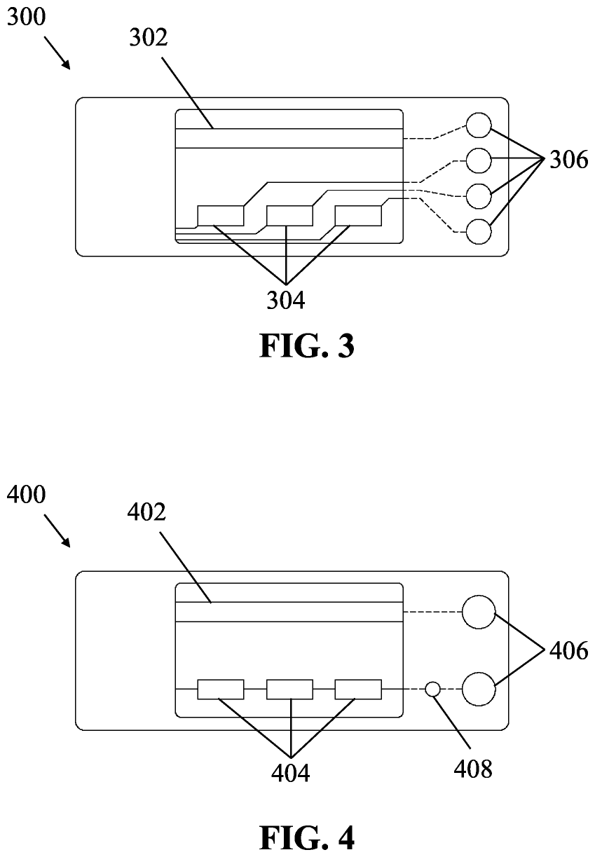

A multimodal test card 300 configured for PCR and LFA is shown in FIG. 3. It includes a channel layer with multiple PCR reaction wells 304 and a cavity that accommodates a LFA strip 302. It is configured to perform both PCR and LFA tests. Each sample is loaded into a different loading port 306. For the PCR part of the test card, each PCR reaction well 304 is fed by its own loading port 306. In some embodiments, the LFA strip 302 contains a single target or multiple targets. The chip is configured to detect three PCR targets and multiple LFA targets.

A multimodal test card 400 configured for PCR and LFA and having a sample processing port is shown in FIG. 4. It includes a channel layer with multiple PCR reaction wells 404 and a cavity that accommodates a LFA strip 402. It is configured to perform both PCR and LFA tests. For the PCR tests, a rehydration port (as a representative example of an intermediate sample processing port) 408 is included in the microfluidic chip or in the chip carrier. The rehydration port is located between the loading port 406 and the reaction wells 404. It contains lyophilized beads or pellets, which contain the required reagents to perform a PCR. The PCR sample is dispensed in the loading port 406, the sample rehydrates the lyophilized pellet, and then the sample is pulled into the PCR wells 404.

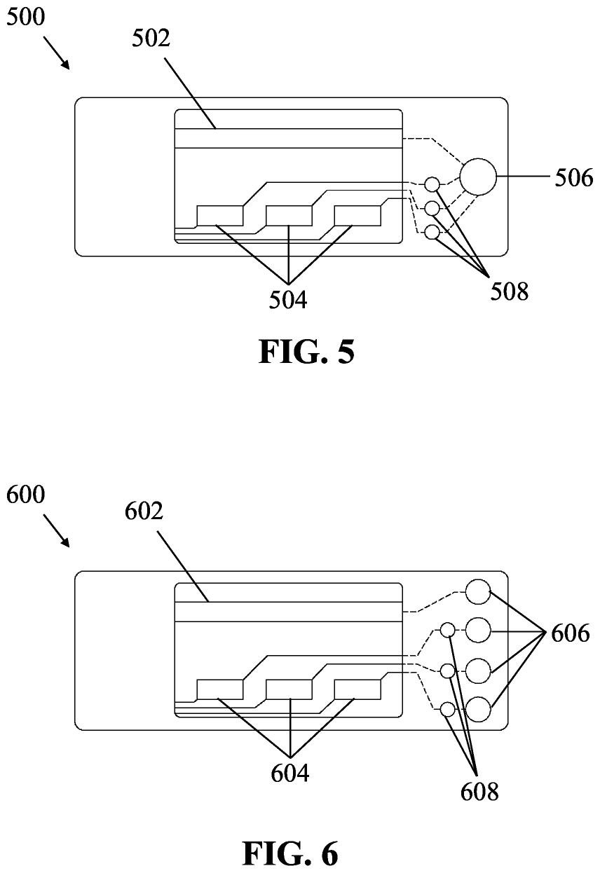

A multimodal test card 500 configured for PCR and LFA and having a sample processing port and a single loading port is shown in FIG. 5. It includes a channel layer with multiple PCR reaction wells 504 and a cavity that accommodates a LFA strip 502. It is configured to perform both PCR and LFA tests. One loading port 506 feeds the PCR and LFA tests. The microfluidic chip in the test card has three reactions wells 504 and a rehydration port 508 before each reaction well. The rehydration ports 508 hold lyophilized beads or pellets, which contain the required reagents to perform a PCR. The PCR sample is dispensed in the loading port 506, the sample rehydrates the lyophilized pellet, and then the sample is pulled into the PCR wells 504.

A multimodal test card 600 configured for PCR and LFA and having multiple sample processing ports and multiple loading ports is shown in FIG. 6. It includes a channel layer with multiple PCR reaction wells 604 and a cavity that accommodates a LFA strip 602. It is configured to perform both PCR and LFA tests. Multiple ports 606 feed the PCR and LFA tests. The microfluidic chip has three reactions wells 604 and a rehydration port 608 before each reaction well 604. The rehydration ports 608 hold lyophilized beads or pellets, which contain the required reagents to perform a PCR. Each PCR sample is dispensed in the separate loading ports 606, they individually rehydrate the separate lyophilized pellets in the rehydration port 608, and then they are individually pulled into the individual PCR wells 604.

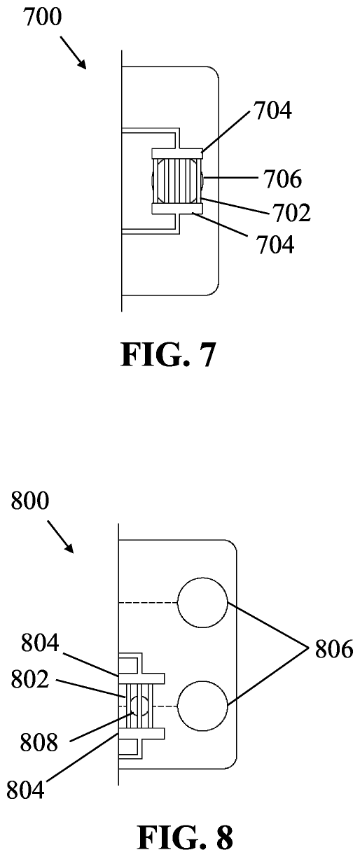

A heater 702 for use in a test card 700 is shown in FIG. 7. The heater 702 is depicted below a loading port 706, making the loading port a heated loading port. The heater 702 is a resistive heater located between electrodes 704. In some embodiments, it comprises three to four layers of polycarbonate (PC) lamination. The heater 702 is a printed or adhered heater. The heated loading port 706 provides an optional incubation step for RNA-based PCR tests prior to the loading on the chip. It serves to extract RNA. The heater 702 is broadly applicable to various tests on the chip, including PCR tests.

A heater 802 for use in a test card 800 is shown in FIG. 8. The heater 802 is depicted after a loading port 806 and below a rehydration port 808, making the rehydration port 808 a heated rehydration port. The heater 802 is a resistive heater located between electrodes 804. In some embodiments, it comprises three to four layers of polycarbonate (PC) lamination. The heater 802 is a printed or adhered heater. The heated rehydration port 808 provides a pre-incubation step to remove rehydration bubbles and/or perform incubation for some tests, including PCR tests.

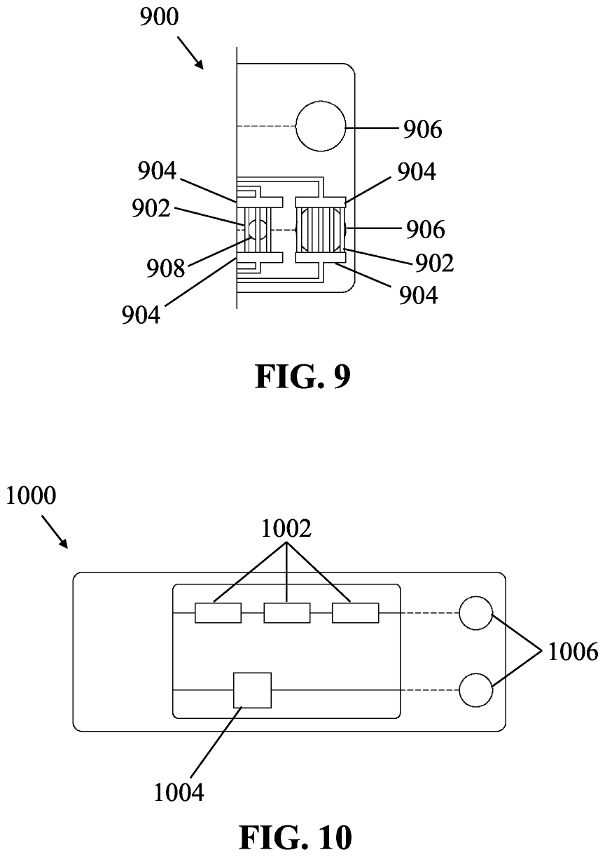

Multiple heaters 902 for use in a test card 900 are shown in FIG. 9. The heaters 902 are depicted below a loading port 906 and a rehydration port 908, making the loading port 906 a heated loading port and the rehydration port 908 a heated rehydration port. The heaters 902 are resistive heaters located between electrodes 904. This combination of heaters combines the individual benefits for heated loading ports and heated rehydration ports.

A multimodal test card 1000 configured for PCR and cytometry tests and having multiple loading ports is shown in FIG. 10. It includes a channel layer with multiple PCR reaction wells 1002 and a parallel channel layer with a cytometry well 1004. It is configured to perform both PCR and cytometry tests. The cytometry well 1004 collects red and white blood cells for visual analysis (e.g., size, physical properties, composition, count, etc.). The different testing modes are fluidically separated. Separate loading ports 1006 feed the associated PCR and cytometry tests such that each different testing mode is fed by a different loading port 1006.

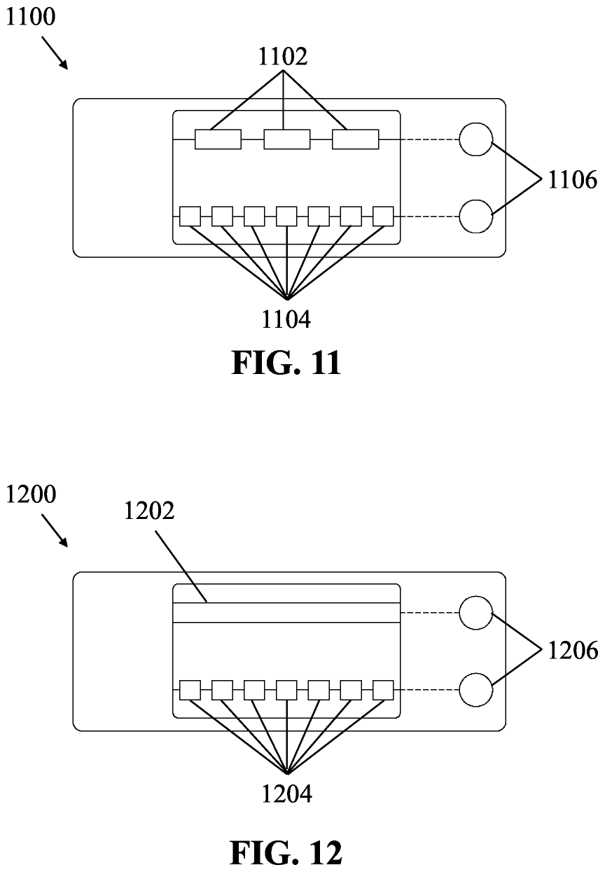

A multimodal test card 1100 configured for PCR and assays and having multiple loading ports is shown in FIG. 11. It includes a channel layer with multiple PCR reaction wells 1102 and a parallel channel layer with multiple assay pads or strips 1104. It also includes loading ports 1106. It is configured to perform both PCR and assay tests. Each assay may include multiple assay pads or strips (e.g., for colorimetric assays) 1104 located in individual cavities and connected to each other by microfluidic channels. The pads or strips 1104 contain chemicals that interact with the sample. Interactions between the samples and the assay pads or strips alter the pads or strips 1104 (e.g., by inducing a color change that is visually observed).

A multimodal test card 1200 configured for LFA and assays and having multiple loading ports is shown in FIG. 12. It includes a channel layer with a single LFA strip 1202 and a parallel channel layer with multiple assay pads or strips 1204. It also includes loading ports 1206. It is configured to perform both LFA tests and assay tests. Each assay may include multiple assay pads or strips (e.g., for colorimetric assays) 1204 located in individual cavities and connected to each other by microfluidic channels. The pads or strips 1204 contain chemicals that interact with the sample. Interaction between the samples and the assay pads or strips alter the pads or strips 1204 (e.g., by inducing a color change that is visually observed).

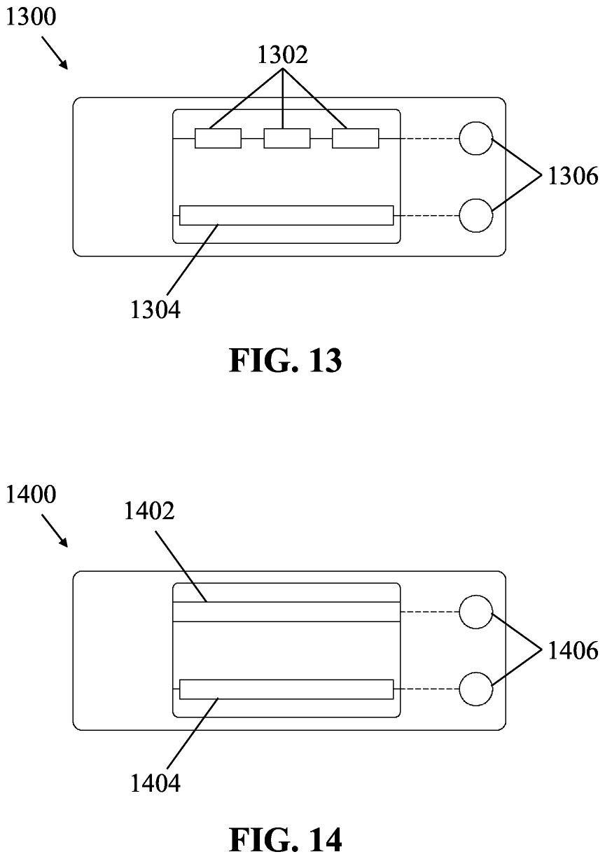

A multimodal test card 1300 configured for PCR and turbidity tests and having multiple loading ports is shown in FIG. 13. It includes a channel layer with multiple PCR reaction wells 1302 and a parallel channel layer with a turbidity measurement channel 1304. It also includes loading ports 1306. It is configured to perform both PCR and turbidity tests. The turbidity measurement channel 1304 measures turbidity and/or other aspects of liquid appearance. Turbidity measurements are useful, for example, to detect particulate matter in a fluid phase.

A multimodal test card 1400 configured for PCR and turbidity tests and having multiple loading ports is shown in FIG. 14. It includes a channel layer with an LFA strip 1402 and a parallel channel layer with a turbidity measurement channel 1404. It also includes loading ports 1406. It is configured to perform both LFA and turbidity tests. The turbidity measurement channel 1404 measures turbidity and/or other aspects of liquid appearance. Turbidity measurements are useful, for example, to detect particulate matter in a fluid phase.

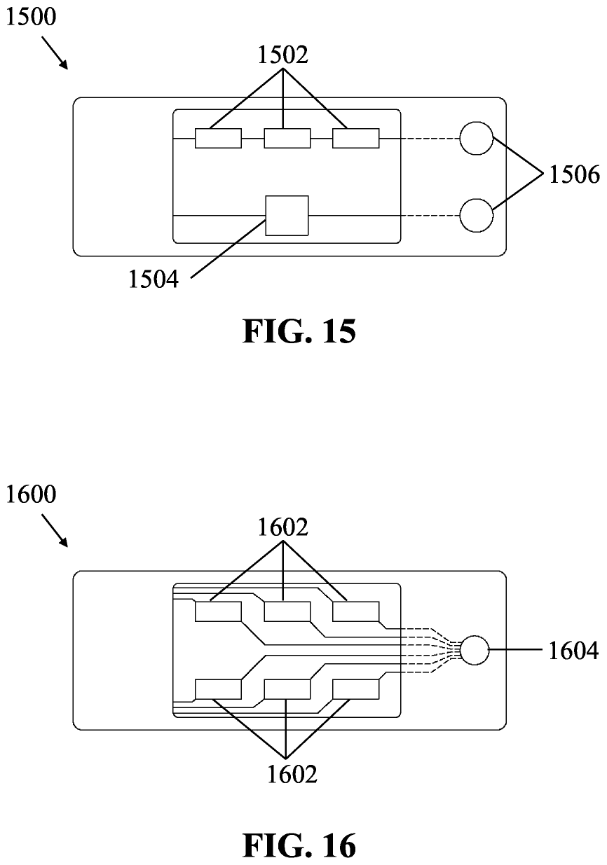

A multimodal test card 1500 configured for PCR and ion selectivity tests and having multiple loading ports is shown in FIG. 15. It includes a channel layer with multiple PCR reaction wells 1502 and a parallel channel layer with a well containing electrode for ion selectivity measurements 1504. It also includes loading ports 1506. It is configured to perform both PCR and ion selectivity tests. The well containing electrode 1504 contains electrodes or ion selective membranes for electrical measurement (e.g., impedance) or electrical stimulation. The electrodes are microfabricated within the chip or integrated within the chip as part of a laminated layer. The electrodes need to be exposed to the outside of the test card for connection.

A multimodal test card 1600 configured for PCR and ion selectivity tests and having a single loading port is shown in FIG. 16. It includes a channel layer with multiple PCR reaction wells 1602. It also includes a loading port 1604. Each PCR well 1602 also contains an electrode (not shown) for ion selectivity measurements. The test card is configured to perform both PCR and ion selectivity tests. The PCR well containing electrode 1602 contains electrodes or ion selective membranes for electrical measurement (e.g., impedance) or electrical stimulation. The electrodes are microfabricated within the chip or integrated within the chip as part of a laminated layer. The electrodes need to be exposed to the outside of the test card for connection.

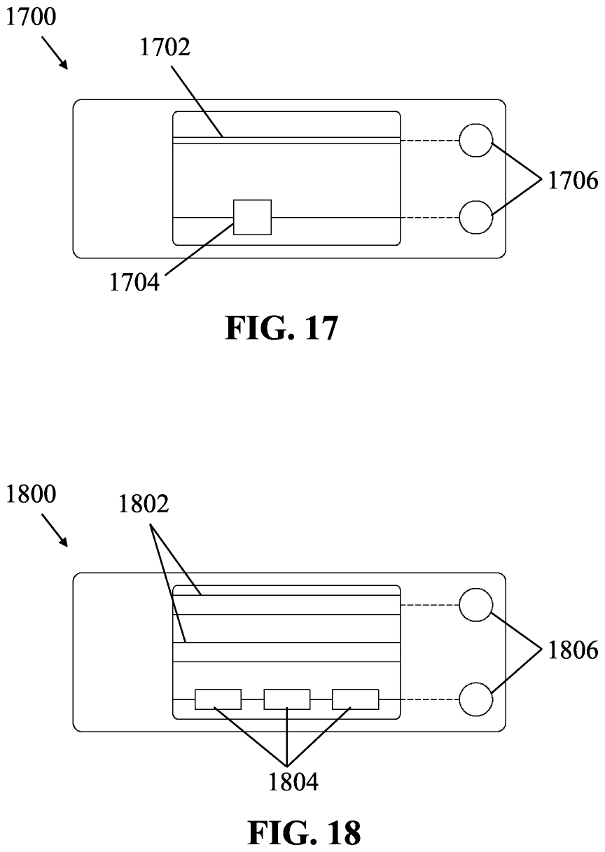

A multimodal test card 1700 configured for viscosity and cytometry tests and having multiple loading ports is shown in FIG. 17. It includes a channel layer with a viscosity measurement channel 1702 and a parallel channel layer with a cytometry well 1704. It also includes loading ports 1706. It is configured to perform both viscosity and cytometry tests. The cytometry well 1704 collects red and white blood cells for visual analysis (e.g., size, physical properties, composition, count, etc.). Viscosity measurements evaluate, for example, how easily a fluid flows. The viscosity measurement channel 1702 may further include a heater underneath for temperature control (not shown). A third loading port and a second viscosity channel (not shown) may also be included on the chip for reference sample measurements.

A multimodal test card 1800 configured for PCR and LFA is shown in FIG. 18. It includes a channel layer with multiple PCR reaction wells 1804 and two separate cavities that each accommodate a LFA strip 1802. It is configured to perform both PCR and LFA tests. It includes separate loading ports 1806 for each LFA strip 1802 and the PCR wells 1804. The PCR sample is loaded into a series of PCR wells (e.g. 3) 1804 with the same target. The test card includes three tests and/or modes. In some embodiments, such a test card is useful for COVID-19 testing. In some embodiments, the PCR tests provide virus genetic information, the first LFA provides virus antigen information, and the second LFA provides antibody information.

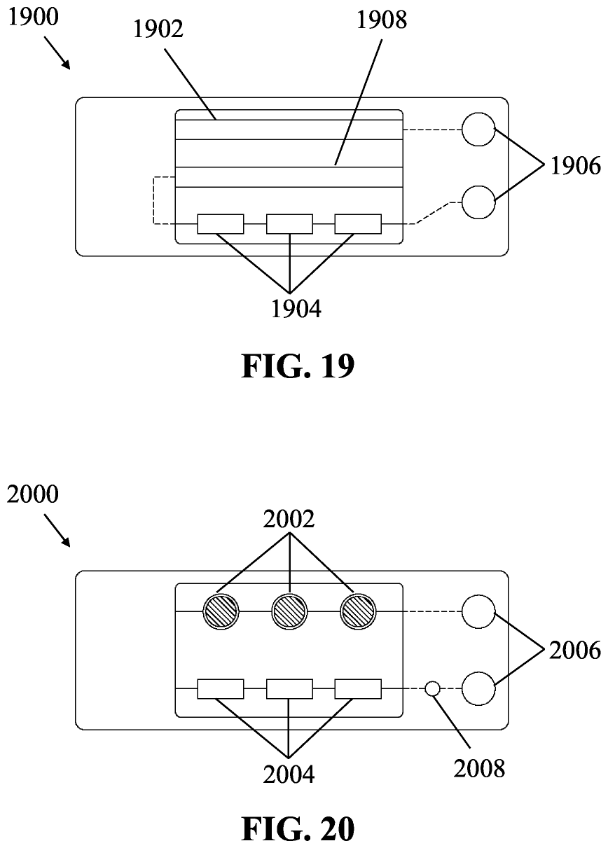

A multimodal test card 1900 configured for PCR and LFA is shown in FIG. 19. It includes a channel layer with multiple PCR reaction wells 1904 and two separate cavities that each accommodate a LFA strip 1902 and 1908. It is configured to perform both PCR and LFA tests. It includes separate loading ports 1906 for the LFA strips 1902. The first LFA strip 1902 is an independent LFA strip with its own loading port. The second LFA strip 1908 is a PCR dependent LFA strip and is connected in series with the PCR wells 1904. The sample loaded in the PCR loading port 1906 is pulled in the PCR wells 1904 then in the LFA strip 1908.

A multimodal test card 2000 configured for PCR and immunochemistry is shown in FIG. 20. It includes a channel layer with multiple PCR reaction wells 2004 and a channel layer with multiple immunochemistry wells 2002. It is configured to perform both PCR and immunochemistry tests. It includes separate loading ports 2006 for the immunochemistry wells 2002 and the PCR wells 2004. The PCR sample is loaded into a series of PCR wells (e.g. 3) 2004 with the same target. A single lyophilized bead in a rehydration chamber 2008 is used before the PCR wells 2004. Each immunochemistry well contains a polymeric disc that is coated with reagents required for immunochemistry testing. The reagents could alternatively be coated directly onto the microfluidic channel.

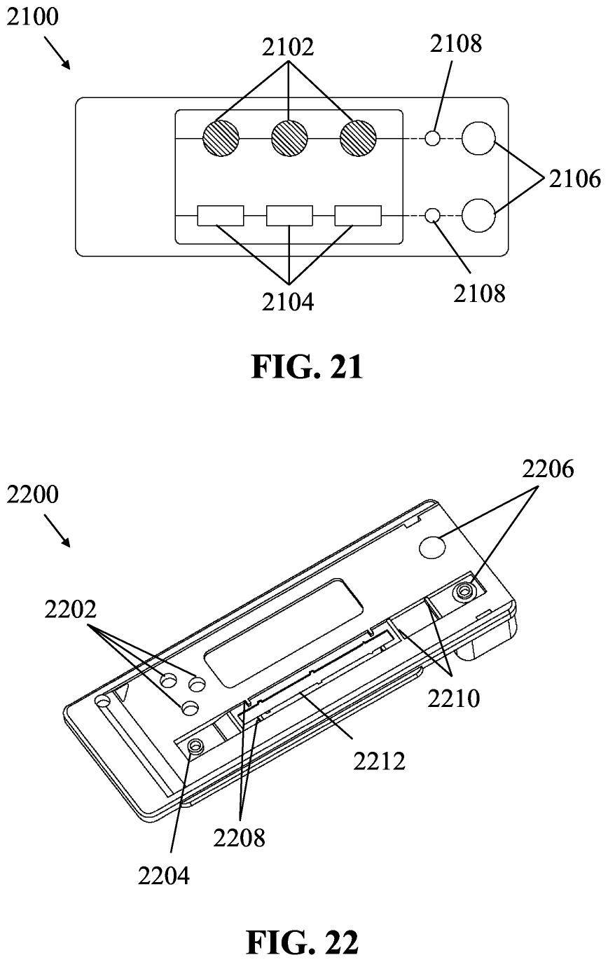

A multimodal test card 2100 configured for PCR and immunochemistry is shown in FIG. 21. It includes a channel layer with multiple PCR reaction wells 2102 and a channel layer with multiple immunochemistry wells 2104. It is configured to perform both PCR and immunochemistry tests. It includes separate loading ports 2106 for the immunochemistry wells 2102 and the PCR wells 2104. The PCR sample is loaded into a series of PCR wells (e.g. 3) 2104 with the same target. A single lyophilized bead in a rehydration chamber 2108 is used before the PCR wells 2104. A single lyophilized bead in a rehydration chamber 2108 is also used before the immunochemistry wells 2102. Each lyophilized bead contains modality-specific reagents.

A chip carrier 2200 for a multimodal test card is shown in FIG. 22. The chip carrier 2200 is configured to couple to a microfluidic chip configured for LFA testing and PCR testing (not shown). It includes PCR and LFA fluid capture ports 2202 and 2204, respectively, two fluid inlets optionally including a pressure point 2206, LFA strip placement guides 2208, LFA fluid flow rate pressure points 2210, and a viewing window for LFA 2212. These components generally serve the same purpose as components for singleplex PCR tests with several exceptions. First, the carrier 2200 provides localized pressure points on the LFA strip surface (not shown), which is required for flow regulation through the strip. Second, the carrier 2200 provides a fluid capture zone 2204 for the LFA strip. The cover layer is not pierced in the area of this fluid capture zone. Third, the microfluidic chip sub-assembly provides clamping pressure to the LFA strip against the pressure points on the carrier 2200.

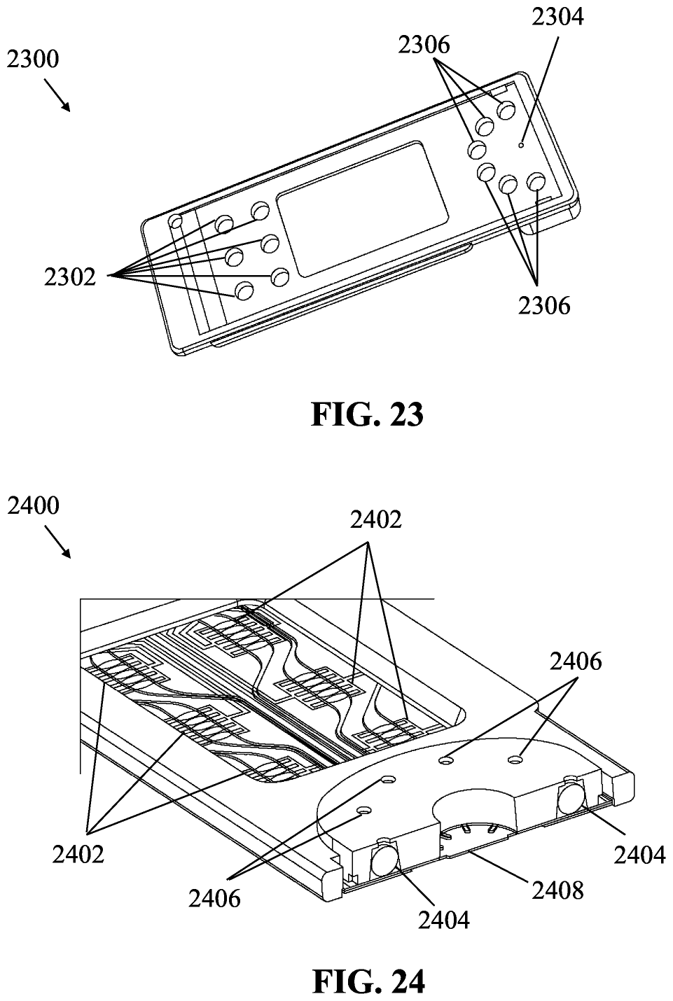

A chip carrier 2300 for a multimodal test card is shown in FIG. 23. The chip carrier includes fluid capture ports 2302, a single fluid inlet 2304, and place holders 2306 for sample processing components (e.g. lyophilized pellets, not shown).

A multimodal test card 2400 including rehydration ports 2404 is shown in FIG. 24. The multimodal test card 2400 is configured to perform six PCR tests, as shown by the six test zone heaters 2402. The two rehydration ports 2404 each include air vents 2406 for releasing air during rehydration of lyophilized pellets or beads. The air vents 2406 can prevent issues with bubbles trapped in the microchannels. These components generally serve the same purpose as components for singleplex PCR tests with several exceptions. First, the test card 2400 retains the lyophilized pellets or beads in rehydration ports 2404. Second, the test card 2400 provides air vents 2406 to allow air generated during rehydration processes to escape. Without these air vents 2406, gas bubbles can be introduced into the microchannels. Third, the microfluidic chip sub-assembly can retain the lyophilized pellet (not shown). Fourth, additional heaters (not shown) at the loading ports 2408 improve mixing of reagents and reduce bubbles produced during rehydration. Fifth, a cap (not shown) prevents fluid from escaping through the air vents.

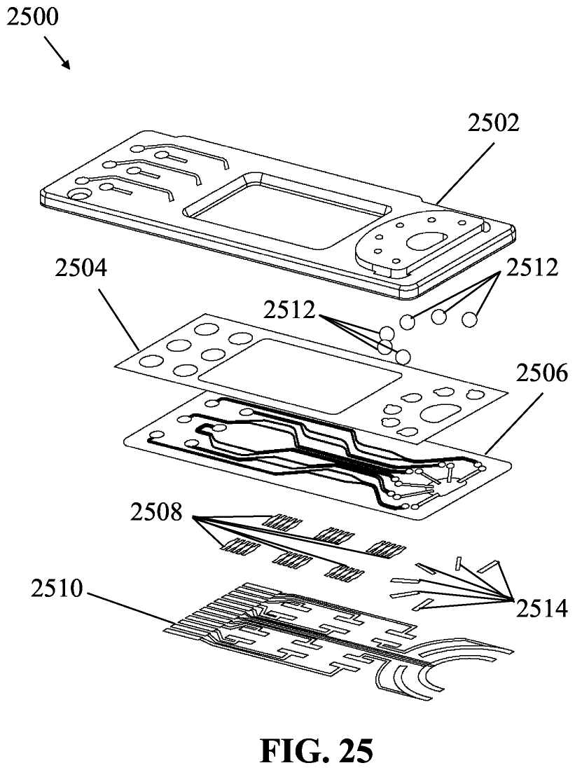

A multimodal test card 2500 is shown in FIG. 25. The test card 2500 is shown in an expanded view with the components separated. The components present a shared, modular architecture for the test card. The test card 2500 includes a cover layer (not shown), chip carrier 2502, adhesive layer 2504, loading port cap (not shown), and a microfluidic chip sub-assembly 2506 including a channel mask, seal layer, channel layer, base layer, heaters 2508, electrical components (e.g., silver traces) 2510, and a dielectric component (e.g., dielectric tape, not shown). The multimodal test card 2500 is configured to perform six PCR tests, as shown by the six lyophilized beads 2512 and the six test zone heaters 2508. The loading port cap, dielectric layer, cover layer, and channel mask are not shown. The three-layer microfluidic chip sub-assembly 2506 has extra pathways for routing samples to and from the pellet. Additional heaters 2514 increase the rate of lyophilized bead or pellet rehydration.

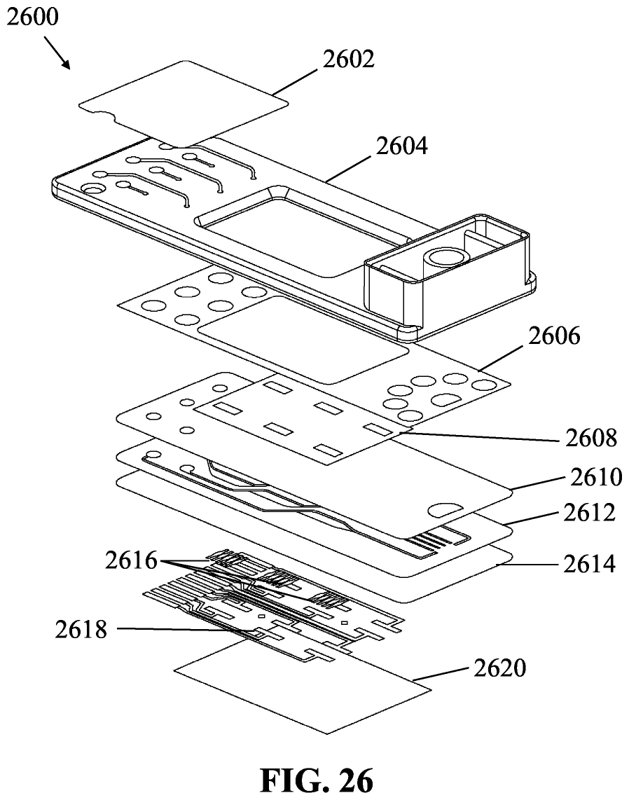

A multimodal test card 2600 is shown in FIG. 26. The test card 2600 is shown in an expanded view with the components separated. The components present a shared, modular architecture for the test card 2600. The test card 2600 includes a cover layer 2602, chip carrier 2604, adhesive layer 2606, loading port cap (not shown), and a microfluidic chip sub-assembly that includes a channel mask 2608, seal layer 2610, channel layer 2612, base layer 2614, heaters 2616, electrical components (e.g., silver traces) 2618, and a dielectric component (e.g., dielectric tape) 2620.

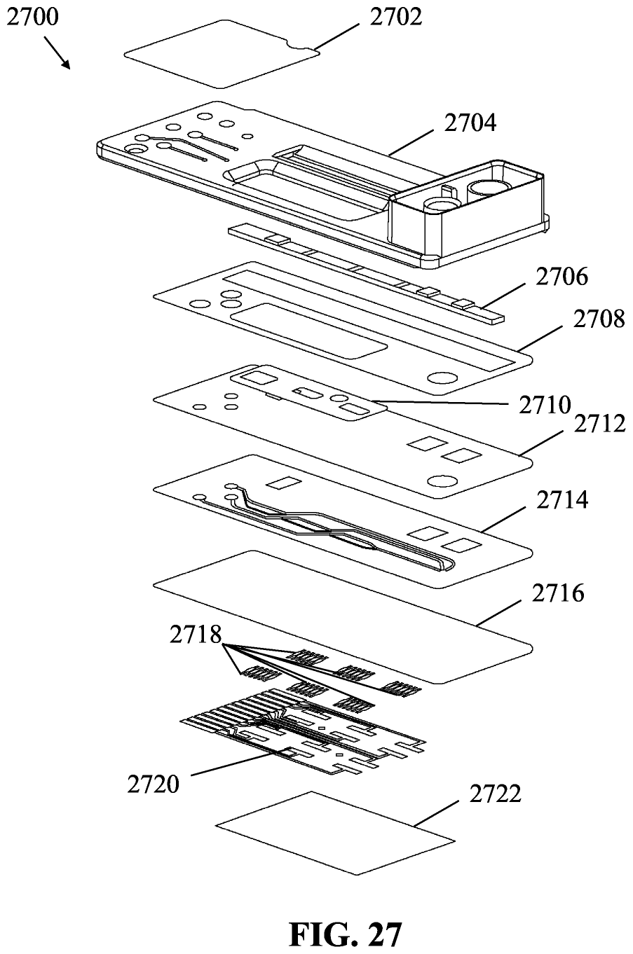

A multimodal test card 2700 is shown in FIG. 27. The test card 2700 is shown in an expanded view with the components separated. The components present a shared, modular architecture for the test card 2700. The test card 2700 includes a cover layer 2702, chip carrier 2704, an LFA strip between the chip carrier and an adhesive layer 2706, the adhesive layer 2708, loading port cap (not shown), and a microfluidic chip sub-assembly that includes a channel mask 2710, seal layer 2712, channel layer 2714, base layer 2716, heaters 2718, electrical components (e.g., silver traces) 2720, and a dielectric component (e.g., dielectric tape) 2722.

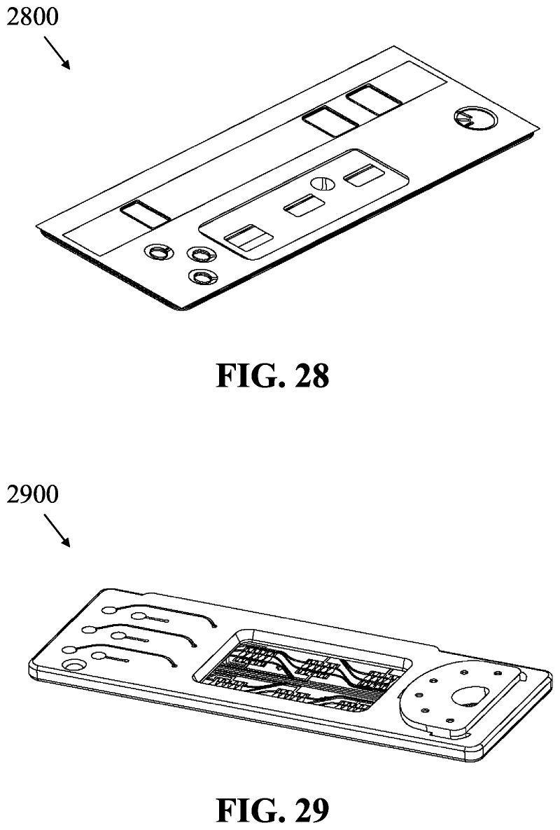

An assembled chip carrier for a multimodal test card 2800 is shown in FIG. 28. The chip carrier 2800 is configured to be coupled to a microfluidic chip (not shown) configured for LFA testing and PCR testing.

An assembled multimodal test card 2900 is shown in FIG. 29. The test card 2900 is configured for PCR testing.

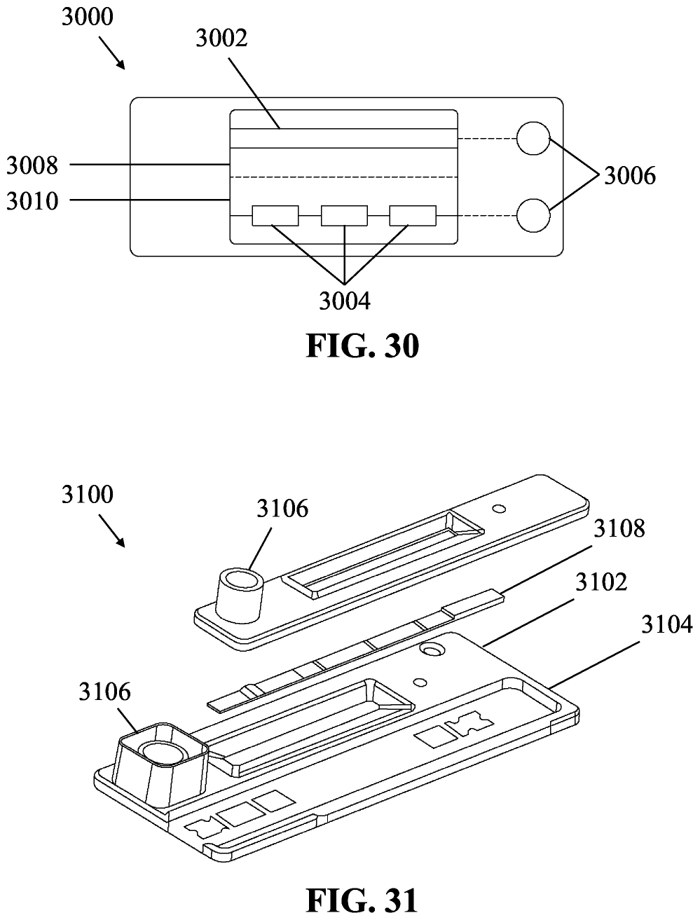

An assembled multimodal test card 3000 is shown in FIG. 30. It includes a channel layer with multiple PCR reaction wells 3004 and a cavity that accommodates a LFA strip 3002. Each sample is loaded into a different loading port 3006. The test card 3000 is configured for PCR and LFA testing with multiple chips. The first chip 3008 contains the LFA strip 3002 and the second chip 3010 contains the PCR reaction wells 3004.

An assembled multimodal test card 3100 is shown in FIG. 31. The test card 3100 is configured for LFA testing. It includes a channel layer with a first LFA strip 3102 and a parallel channel layer with a second LFA strip 3104. In FIG. 31, the parallel channel layer with a second LFA strip 3104 is shown in an exploded view. The assembled multimodal test card 3100 also includes loading ports 3106. The channel layer with a first LFA strip 3102 has a microfluidic channel as a microfluidic guide to direct fluid from the loading port 3106 to a first LFA strip (not shown). The channel layer with a second LFA strip 3104 has a direct fluidic connection as a microfluidic guide to direct fluid from the loading port 3106 to a second LFA strip 3108.

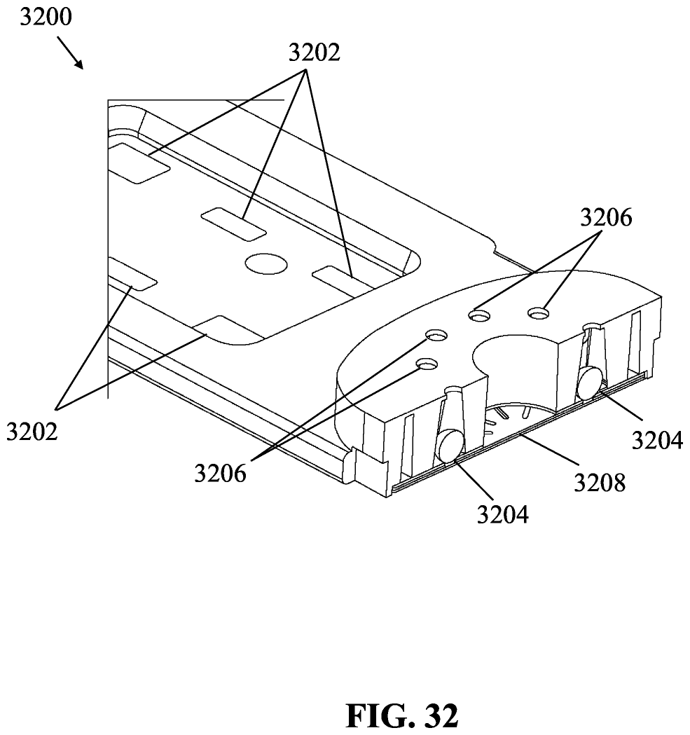

A multimodal test card 3200 including rehydration ports 3204 is shown in FIG. 32. The multimodal test card 3200 is configured to perform six PCR tests, as shown by the PCR reaction wells 3202. Five of six total PCR reaction wells 3202 are visible. The two rehydration ports 3204 each include air vents 3206 for releasing air during rehydration of lyophilized pellets or beads. The air vents 3206 can prevent issues with bubbles trapped in the microchannels. These components generally serve the same purpose as components for singleplex PCR tests with several exceptions. First, the test card 3200 retains the lyophilized pellets or beads in rehydration ports 3204. Second, the test card 3200 provides air vents 3206 to allow air generated during rehydration processes to escape. Without these air vents 3206, gas bubbles can be introduced into the microchannels. Third, the microfluidic chip sub-assembly can retain the lyophilized pellet (not shown). Fourth, additional heaters (not shown) at the loading ports 3208 improve mixing of reagents and reduce bubbles produced during rehydration. Fifth, a cap (not shown) prevents fluid from escaping through the air vents.

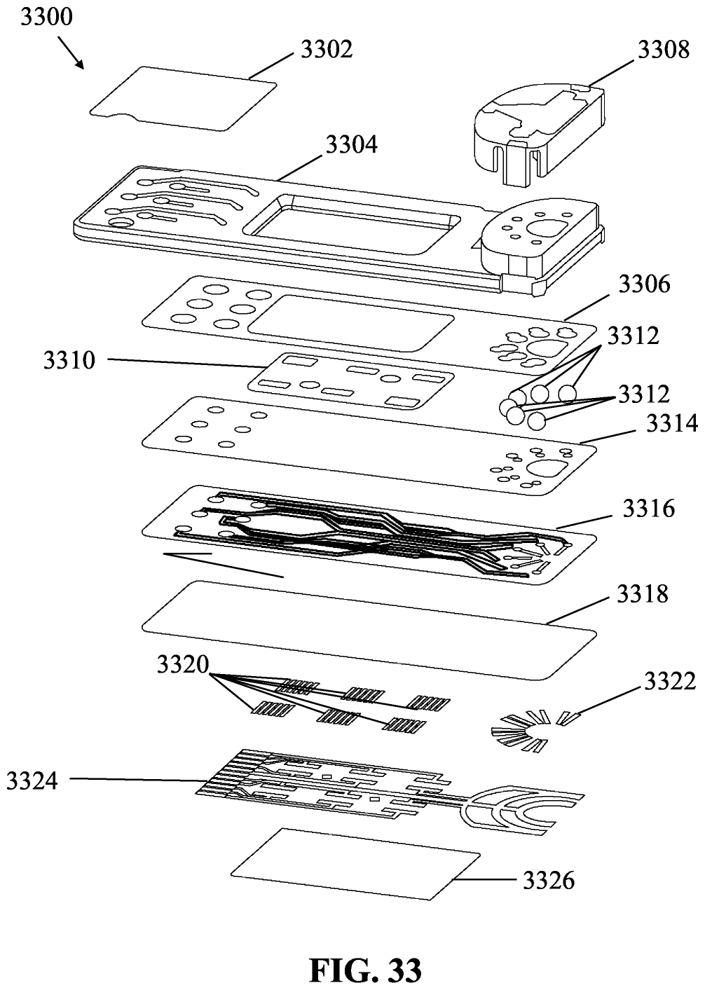

A multimodal test card 3300 is shown in FIG. 33. The test card 3300 is shown in an expanded view with the components separated. The components present a shared, modular architecture for the test card 3300. The test card 3300 includes a cover layer 3302, chip carrier 3304, adhesive layer 3306, loading port cap 3308, and a microfluidic chip sub-assembly that includes a channel mask 3310, seal layer 3314, channel layer 3316, base layer 3318, heaters 3320, electrical components (e.g., silver traces) 3324, and a dielectric component (e.g., dielectric tape) 3326. The multimodal test card 3300 is configured to perform six PCR tests, as shown by the six lyophilized beads 3312 and the six test zone heaters 3320. The loading port cap, dielectric layer, cover layer, and channel mask are not shown. The three-layer microfluidic chip sub-assembly 3316 has extra pathways for routing samples to and from the pellet. Additional heaters 3322 increase the rate of lyophilized bead or pellet rehydration.

Described herein is a multimodal test card. The test card includes a shared, modular architecture that enables performing a variety of tests, such as diagnostic tests, for multimodal analysis. The shared architecture comprises standardized fluidic and electrical components. The test card is capable of performing singleplex and/or multiplex diagnostic analyses, as described herein.

In many embodiments, the test card comprises a microfluidic chip and a chip carrier.

The test card includes a shared architecture having several components. In some embodiments, the test card comprises a component selected from the group consisting of a cover layer, a chip carrier, an adhesive layer, a loading port cap, a microfluidic chip, a channel mask, a seal layer, a channel layer, a base layer, a heater, an electrical component, a dielectric component, a rehydration port cap, and combinations thereof. In some embodiments, the microfluidic chip comprises a component selected from the group consisting of a channel mask, a seal layer, a channel layer, a base layer, a heater, an electrical component, a dielectric component, a rehydration port cap, and combinations thereof. In many embodiments, at least one component is configured for optical interrogation by a testing device. In many embodiments, at least one component is optically transparent.

In some embodiments, the chip carrier is coupled to the microfluidic chip with a coupling mechanism selected from the group consisting of mechanical couplings, chemical couplings, adhesives, a welding, an ultrasonic welding, a laser welding, a melt welding, and combinations thereof.

In some embodiments, the chip carrier comprises a component selected from the group consisting of a circuit element, an electrical component, an electrode, a fan, a heater, a cooler, a magnet, an optical component, a lens, a transparent lens, and combinations thereof.

In some embodiments, the heater heats a component selected from a loading port, a sample processing port, a testing zone, a microfluidic channel, and combinations thereof.

In some embodiments, an external fan cools a component selected from a loading port, a sample processing port, a testing zone, a microfluidic channel, and combinations thereof.

In some embodiments, the test card comprises an adhesive layer between the microfluidic chip and the chip carrier.

In some embodiments, the test card comprises a temperature sensitive layer underneath the chip carrier. In some embodiments, the temperature sensitive layer comprises a dielectric component. In some embodiments, the temperature sensitive layer comprises a dielectric tape.

In some embodiments, the temperature sensitive layer is used to directly detect a temperature of the test card. In some embodiments, an external temperature sensor (e.g., an infrared sensor) is used to measure the temperature of the temperature sensitive layer to determine the temperature of the test card.

In some embodiments, the chip carrier comprises an additional component. In some embodiments, the chip carrier comprises an additional component for sample handling, sample processing, and/or testing. In some embodiments, the chip carrier comprises an additional component that is positioned below a component of the microfluidic chip. In some embodiments, the chip carrier comprises a heater positioned underneath a component of the microfluidic chip selected from the group consisting of an input port, a sample processing port, a rehydration port, a test zone, a pneumatic actuation port, a fluid capture port, a radio-frequency identification (RFID) tag, and combinations thereof.

In some embodiments, the test card performs multiple tests on at least one sample. In some embodiments, the test card performs at least one test on multiple samples. In some embodiments, the test card simultaneously performs multiple tests on at least one sample. In some embodiments, the test card performs at least one test on multiple samples simultaneously.

In many embodiments, the test card comprises a shared architecture comprising elements of standard size. As one non-limiting example, in some embodiments, electrical interface contacts are of standardized spacing known in the PCB and electronics industry.

In many embodiments, the test card comprises an electrical contact and/or a pneumatic port near a rear end of the card. Such an orientation enables design flexibility for changing microfluidic channels, electric circuit designs, total length of the test card and microfluidic chip, and/or loading port designs.

In many embodiments, the test card comprises a loading port outside of a machine envelope. Such an orientation enables design space for customizing loading ports for each individual sample type.

Further, in many embodiments, the test card includes a viewing window positioned to enable a camera on an analyzing device to analyze one or more tests performed using the test card.

Also described herein is a microfluidic chip comprising at least one input port fluidically connected to at least two test zones by at least one microfluidic guide, wherein the at least two test zones are configured to perform at least two different tests. In many embodiments, the at least one microfluidic guide is selected from the group consisting of a microfluidic channel, a direct fluidic connection with a test modality that directs microfluidic flow, and combinations thereof.

In some embodiments, at least one input port is fluidically connected to at least one test zone by at least one microfluidic guide. In some embodiments, at least one input port is fluidically connected to at least two test zones by at least one microfluidic guide. In some embodiments, at least one input port is fluidically connected to at least two test zones by at least two microfluidic guides.

In some embodiments, at least one input port is fluidically connected to a test zone by a microchannel.

In some embodiments, at least one input port is directly fluidically connected to a test zone. In these embodiments, the at least one input port is in direct fluidic communication with the test zone. In some embodiments, at least one input port is directly fluidically connected to a test zone, wherein the test zone comprises an LFA test. In these embodiments, the microfluidic properties of the LFA test direct fluid flow and thereby serve as a microfluidic guide.

In some embodiments, the at least two different tests comprise two different tests with the same testing mode (e.g., both PCR tests). In some embodiments, the at least two different tests comprise two different tests with different testing modes (e.g., a PCR test and an LFA test).

In many embodiments, the microfluidic chip comprises an additional component. In some embodiments, the microfluidic chip comprises an additional component for sample handling, sample processing, and/or testing. In some embodiments, the microfluidic chip comprises an additional component in the microchannel. In some embodiments, the microfluidic chip comprises an additional component below the microchannel. In some embodiments, the microfluidic chip comprises an additional component above the microchannel. In some embodiments, the microfluidic chip comprises an additional component adjacent to the microchannel. In some embodiments, the microfluidic chip comprises an additional component connected to the microchannel.

In some embodiments, the microfluidic chip comprises a component selected from the group consisting of an additional input port, an additional microchannel, a sample processing port, a rehydration port, a test zone, and combinations thereof.

In some embodiments, the microfluidic chip comprises a heater positioned underneath a component selected from the group consisting of an input port, a sample processing port, a rehydration port, a test zone, and combinations thereof.

In some embodiments, the sample is pre-processed before being loaded onto the microfluidic chip. In some embodiments, the pre-processing comprises a method step selected from the group consisting of centrifugation, mixing with reagents, mixing with buffers, mixing with solutions, agitation, mechanical agitation, ultrasonic agitation, vortexing, lysing, mechanical lysing, heating, cooling, and combinations thereof.

In many embodiments, the sample is processed on the microfluidic chip. In some embodiments, the processing comprises a method step selected from the group consisting of centrifugation, mixing with reagents, mixing with buffers, mixing with solutions, agitation, mechanical agitation, ultrasonic agitation, vortexing, lysing, mechanical lysing, heating, cooling, and combinations thereof.

In some embodiments, the microfluidic chip comprises a sample processing component. In some embodiments, the sample processing component is selected from the group consisting of reagents, polymers comprising reagents, polymer discs coated with reagents, lyophilized beads, lyophilized pellets, and combinations thereof. In some embodiments, the microfluidic chip comprises a sample processing component in a location selected from the group consisting of a sample processing port, a rehydration port, a loading port, a microchannel, a test zone, and combinations thereof.

In some embodiments, the microfluidic chip comprises a sample processing port positioned in the microchannel upstream from a test zone. In some embodiments, the sample processing port is located between a loading port and a test zone. In some embodiments, the sample processing ports include reagents. In some embodiments, the port is a rehydration port. In some embodiments, the rehydration port comprises a lyophilized bead or pellet. In some embodiments, the sample rehydrates the lyophilized pellet.

In some embodiments, the microfluidic chip comprises a sample processing port before each test zone. In some embodiments, the microfluidic chip comprises a sample processing port before each testing mode, wherein the testing mode includes at least one test zone.

In some embodiments, the test zone comprises a single test. In some embodiments, the test zone comprises multiple tests of the same testing mode.

In many embodiments, the test zones are configured to allow for concurrent testing. In some embodiments, the at least two test zones are not fluidically connected. In some embodiments, the at least two test zones are arranged in parallel.

In many embodiments, the test zones are configured to allow for sequential testing. In some embodiments, the at least two test zones are fluidically connected. In some embodiments, the at least two test zones are arranged in series.

In some embodiments, the test zones are configured to allow for sequential testing and concurrent testing. In some embodiments, at least two test zones are fluidically connected and at least two test zones are not fluidically connected. In some embodiments, at least two test zones are arranged in series and at least two test zones are arranged in parallel.

In many embodiments, a test zone is configured to perform a test. In some embodiments, a test zone is configured to perform a diagnostic test. In some embodiments, a test zone is configured to perform a diagnostic test known in the art. In some embodiments, each test zone is individually configured to perform a test selected from the group consisting of a nucleic acid amplification test (NAAT), a polymerase chain reaction (PCR) test, a reverse-transcription polymerase chain reaction (RT-PCR) test, an isothermal amplification test, a loop mediated isothermal amplification (LAMP) test, an antigen test, an assay test, a chemistry test, an immunochemistry test, a lateral flow assay test, an enzyme-linked immunosorbent assay test, an antibody test, a colorimetric test, a turbidity test, a viscosity test, a light scattering test, a cytometry test, an ion selectivity test, and combinations thereof.

In some embodiments, a test zone is configured to perform a test on a sample from a subject. In some embodiments, the sample is selected from the group consisting of unprocessed biological fluids, processed biological fluids, blood, serum, plasma, urine, feces, saliva, tears, sweat, semen, sputum, lysed tissue, and combinations thereof.

In some embodiments, a test zone is configured to perform a diagnostic test on at least one, at least two, at least three, at least four, at least five, at least six, at least seven, at least eight, at least nine, or at least ten samples.

In some embodiments, a test zone is configured to perform at least one, at least two, at least three, at least four, at least five, at least six, at least seven, at least eight, at least nine, or at least ten tests on a sample.

In many embodiments, the microfluidic chip comprises a sufficient number of test zones to provide a multimodal diagnostic analysis. In many embodiments, the number of test zones depends on the desired diagnostic information. In many embodiments, the number of test zones is limited only by the available space on the microfluidic chip. In many embodiments, the number of test zones is limited by an interface with a testing device. In many embodiments, the test card fits within a testing device.

In some embodiments, the microfluidic chip comprises at least two, at least three, at least four, at least five, at least six, at least seven, at least eight, at least nine, at least ten, at least eleven, at least twelve, at least thirteen, at least fourteen, at least fifteen, at least sixteen, at least seventeen, at least eighteen, at least nineteen, at least twenty, at least twenty-one, at least twenty-two, at least twenty-three, at least twenty-four, at least twenty-five, at least twenty-six, at least twenty-seven, at least twenty-eight, at least twenty-nine, or at least thirty test zones. In some embodiments, the microfluidic chip comprises at least three test zones.

In some embodiments, at least two test zones are configured to perform different testing modes. In some embodiments, at least two test zones are configured to perform the same testing mode. As used herein, a testing mode is a unique type of test.

In some embodiments, the at least two test zones are configured to perform the same testing mode to analyze the same targets. In some embodiments, the at least two test zones are configured to perform the same testing mode to analyze different targets. In some embodiments, the at least two test zones are configured to perform the same testing mode to analyze multiple targets. In some embodiments, the at least two test zones are configured to perform the same testing mode to analyze at least one, at least two, at least three, at least four, at least five, at least six, at least seven, at least eight, or at least nine identical targets.

In many embodiments, the microfluidic chip is sufficiently large to comprise at least two, at least three, at least four, at least five, at least six, at least seven, at least eight, at least nine, at least ten, at least eleven, at least twelve, at least thirteen, at least fourteen, at least fifteen, at least sixteen, at least seventeen, at least eighteen, at least nineteen, at least twenty, at least twenty-one, at least twenty-two, at least twenty-three, at least twenty-four, at least twenty-five, at least twenty-six, at least twenty-seven, at least twenty-eight, at least twenty-nine, or at least thirty test zones. In some embodiments, the microfluidic chip is sufficiently small to engage with the chip holder and fit inside a testing device.

In many embodiments, the microfluidic chip comprises a polymer. In some embodiments, the microfluidic chip comprises polymeric layers. In some embodiments, the microfluidic chip comprises at least one, at least two, at least three, at least four, at least five, or at least six polymeric layers.

In many embodiments, the polymer comprises a material known in the art. In some embodiments, the polymer comprises a material selected from the group consisting of a transparent polymer, polycarbonate, cyclic olefin, cyclic olefin copolymer, polyester, polyether, polyacrylate, polyethylene, polypropylene, polyethylene terephthalate, biaxially-oriented polyethylene terephthalate, and combinations thereof. In some embodiments, the polymer is coated with a thin film coating to enhance transmission of emitted light.

In some embodiments, the microfluidic chip comprises at least one, at least two, at least three, at least four, at least five, at least six, at least seven, at least eight, at least nine, or at least ten input ports. In many embodiments, the number of input ports depends on the numbers and modes of desired tests.

In some embodiments, each input port is fluidically connected to a separate test zone. In some embodiments, at least two input ports are fluidically connected to the same test zone.

In some embodiments, each input port is fluidically connected to at least two test zones configured to perform the same testing mode.

Also described herein is a method of making a microfluidic chip.

In some embodiments, the method of making the microfluidic chip comprises a technique selected from the group consisting of injection molding, extrusion, three-dimensional printing, laminating, microlaminating, hot laminating, embossing, hot embossing, die cutting, adhesive bonding, welding, laser welding, ultrasonic welding, screen printing, stencil printing, inkjet printing, and combinations thereof.

In some embodiments, the method of making the microfluidic chip comprises providing an electrical component. In some embodiments, the electrical component is provided by providing a printed circuit board (PCB). In some embodiments, the electrical component is provided by a printing technique selected from the group consisting of screen printing, stencil printing, inkjet printing, and combinations thereof. In some embodiments, the electrical component is selected from the group consisting of an electrical circuit component, an electric contact, a wire, an electrode, a resistor, a capacitor, and combinations thereof.

In some embodiments, the method of making the microfluidic chip comprises printing an electrode. In some embodiments, the method of making the microfluidic chip comprises printing a conductive electrical component on a dielectric electrical component. In some embodiments, the method of making the microfluidic chip comprises printing a dielectric layer.

In some embodiments, the electrical component comprises a material selected from the group consisting of conductive inks or pastes, silver, gold, platinum, palladium, copper, zinc, conductive carbon, graphite, dielectric inks or pastes, dielectric carbon, carbon, and combinations thereof.

In some embodiments, the method of making the microfluidic chip comprises patterning a microfluidic pattern on a substrate. In some embodiments, a microfluidic pattern is patterned with a pattern mask.

Also described herein is a method of making a test card. The method comprises coupling the microfluidic chip to the chip carrier. In some embodiments, the coupling comprises a coupling mechanism selected from the group consisting of mechanical couplings, chemical couplings, adhesives, a welding, an ultrasonic welding, a laser welding, a melt welding, and combinations thereof.

Also described herein is a use or method of using a test card for diagnosis.

In some embodiments, the method comprises (i) receiving, using a test card, a sample from a subject, the test card including a chip carrier coupled to a microfluidic chip, the microfluidic chip including at least one input port fluidically connected to at least two test zones by at least one microfluidic guide, wherein the at least two test zones are configured to perform at least two different tests; and (ii) testing the sample using the at least two test zones of the test card.

In some embodiments, the methods according to the present disclosure comprise obtaining a biological fluid sample from a subject. In many embodiments, a biological fluid sample is obtained from a subject with a suitable technique known in the art. In some embodiments, the biological fluid sample is tested immediately after being obtained. In some embodiments, the biological fluid sample is stored in refrigerated or non-refrigerated conditions after being obtained.

In many embodiments, the subject is an animal subject, a human subject, or a non-human animal subject. In many embodiments, the subject is any age or gender. In some embodiments, the subject is selected from the group consisting of male children, female children, male adults, female adults, elderly males, and elderly females. In some embodiments, the subject is a human subject.

In many embodiments, a test is used for a variety of purposes. In some embodiments, a test is used for a purpose selected from the group consisting of assessing the health of the subject, monitoring the health of the subject, determining whether intervention is needed to prevent a disease, predicting risk for a disease, providing an early indication of risk for a disease, studying a disease, studying an underlying cause of a disease, diagnosing a disease, providing a prognosis for a disease, and combinations thereof. In some embodiments, multiple tests performed over time are used for time studies. In some embodiments, the multiple tests performed over time are performed with different test cards. In some embodiments, the multiple tests performed over time are performed with a single test card during a single analysis.

In many embodiments, a test includes a variety of individual steps and substeps. In some embodiments, a test comprises a method step selected from the group consisting of identification, detection, quantification, analysis, correlation, and combinations thereof.

In some embodiments, the test card detects a target selected from the group consisting of an infectious agent, an antibody, a nucleic acid, a ribonucleic acid (RNA), a deoxyribonucleic acid (DNA), a locked nucleic acid (LNA), a messenger RNA (mRNA), a circulating tumor DNA (ctDNA), a microRNA (miRNA), and combinations thereof. In some embodiments, the test card detects at least two, at least three, at least four, at least five, at least six, at least seven, at least eight, at least nine, or at least ten targets.

In many embodiments, the test card detects an infectious agent. In some embodiments, the test card detects an infectious agent selected from the group consisting of bacterial pathogens, viral pathogens, fungal pathogens, parasitic pathogens, and combinations thereof.

In many embodiments, the test card detects a known bacterial pathogen. In some embodiments, the test card detects a bacterial pathogen selected from the group consisting of Bacillus (e.g., Bacillus anthracis, Bacillus cereus), Bartonella (e.g., Bartonella henselae, Bartonella quintana), Bordatella (e.g., Bordatella pertussis), Borrelia (e.g., Borrelia burgdorferi, Borrelia garinii, Borrelia afzelii, Borrelia recurrentis), Brucella (e.g., Brucella abortus, Brucella canis, Brucella melitensis, Brucella suis), Campylobacter (e.g., Campylobacter jejuni), Chlamydia (e.g., Chlamydia pneumoniae, Chlamydia trachomatis), Chlamydophila (e.g., Chlamydophila psittaci), Clostridium (e.g., Clostridium botulinum, Clostridium difficile, Clostridium perfringens, Clostridium tetani), Corynebacterium (e.g., Corynebacterium diphtheriae), Enterococcus (e.g., Enterococcus faecalis, Enterococcus faecium), Escherichia (e.g, Escherichia coli), Francisella (e.g., Francisella tularensis), Haemophilus (e.g., Haemophilus influenzae), Helicobacter (e.g., Helicobacter pylori), Legionella (e.g., Legionella pneumophila), Leptospira (e.g., Leptospira interrogans, Leptospira santarosai, Leptospira weilii, Leptospira noguchii), Listeria (e.g., Listeria monocytogenes), Mycobacterium (e.g., Mycobacterium leprae, Mycobacterium tuberculosis, Mycobacterium ulcerans), Mycoplasma (e.g., Mycoplasma pneumoniae), Neisseria (e.g., Neisseria gonorrhoeae, Neisseria meningitidis), Pseudomonas (e.g., Pseudomonas aeruginosa), Rickettsia (e.g., Rickettsia rickettsii), Salmonella (e.g., Salmonella typhi, Salmonella typhimurium), Shigella (e.g., Shigella sonnei), Staphylococcus (e.g., Staphylococcus aureus, Staphylococcus epidermidis, Staphylococcus saprophyticus), Streptococcus (e.g., Streptococcus agalactiae, Streptococcus pneumoniae, Streptococcus pyogenes), Treponema (e.g., Treponema pallidum), Ureaplasma (e.g., Ureaplasma urealyticum), Vibrio (e.g., Vibrio cholerae), Yersinia (e.g., Yersinia pestis, Yersinia enterocolitica, Yersinia pseudotuberculosis), and combinations thereof.

In many embodiments, the test card detects a known viral pathogen. In some embodiments, the test card detects a viral pathogen selected from the group consisting of Adenoviridae (e.g., adenovirus), Herpesviridae (e.g., herpes simplex virus type 1 and type 2, varicella-zoster virus, cytomegalovirus, Epstein-Barr virus, human herpesvirus type 8), Papillomaviridae (e.g., human papillomavirus), Polyomaviridae (e.g., BK virus, JC virus), Poxviridae (e.g., smallpox), Hepadnaviridae (e.g., hepatitis B virus), Parvoviridae (e.g., human bocavirus, parvovirus B19), Astroviridae (e.g., human astrovirus), Caliciviridae, (e.g., Norwalk virus), Picornaviridae (e.g., Coxsackievirus, hepatitis A virus, poliovirus, rhinovirus); Coronaviridae (e.g., severe acute respiratory syndrome virus, Middle East respiratory syndrome virus), Flaviviridae (e.g., hepatitis C virus, yellow fever virus, dengue virus, West Nile virus), Togaviridae (e.g., rubella virus), Hepeviridae (e.g., hepatitis E virus), Retroviridae (e.g., lentiviruses, human immunodeficiency virus); Orthomyxoviridae (e.g., influenza virus), Arenaviridae (e.g., Guanarito virus, Junin virus, Lassa virus, Machupo virus, Sabia virus), Bunyaviridae (e.g., Crimean-Congo hemorrhagic fever virus), Filoviridae (e.g., Ebola virus, Marburg virus), Paramyxoviridae (e.g., measles virus, mumps virus, parainfluenza virus, respiratory syncytial virus, human metapneumonia virus, Hendra virus, Nipah virus), Phabdoviridae (e.g., rabies virus), Reoviridae (e.g., rotavirus, orbivirus, coltivirus, Banna virus), unassigned viruses (e.g., Hepatitis D virus), coronavirus, SARS-CoV-2 (COVID-19), variants of SARS-CoV-2 (COVID-19), and combinations thereof.

In many embodiments, the test card detects a known fungal pathogen. In some embodiments, the multimodal chip detects a fungal pathogen selected from the group consisting of Candida (e.g., Candida albicans), Aspergillus (e.g., Aspergillus fumigatus, Aspergillus flavus), Crytopcoccus (e.g., Cryptococcus neoformans, Cryptococcus laurentii, Cryptococcus gattii), Histoplasma (e.g., Histoplasma capsulatum), Pneumocystis (e.g., Pneumocystis jirovecii, Pneumocystis carinii), Stachybotrys (e.g., Stachybotrys chartarum), and combinations thereof.

In many embodiments, the test card detects a known parasitic pathogen. In some embodiments, the multimodal chip detects a parasitic pathogen selected from the group consisting of acanthamoeba, anisakis, Ascaris lumbricoides, botfly, Balantidium coli, bedbugs, Cestoda (tapeworm), chiggers, Cochliomyia hominivorax, Entamoeba histolytica, Fasciola hepatica, Giardia lamblia, hookworms, Leishmania, Linguatula serrata, liver flukes, Loa loa, Paragonimus—lung fluke, pinworm, Plasmodium falciparum, Schistosoma, Strongyloides stercoralis, mites, tapeworms, Toxoplasma gondii, Trypanosoma, whipworms, Wuchereria bancrofti, and combinations thereof.

In many embodiments, the test card is inserted into a testing device. In some embodiments, the test card is optically interrogated by the testing device. In some embodiments, the optical interrogation comprises an optical technique selected from the group consisting of light scattering, color, transparency, transmittance, absorbance, emission, radiation, fluorescence, spectral imaging, and combinations thereof.

In some embodiments, the test card comprises elements known in the art. In some embodiments, the test card comprises fluidic, electrical, optical, material, or biological elements known in the art. Representative elements are found in U.S. Pat. Nos. 10,214,772; 10,519,493; US 2020/0238283; U.S. Pat. Nos. 9,180,652; 9,120,298; US 2016/0369322; and US 2015/0086443, all of which are incorporated by reference herein in their entirety.

### EXAMPLES

Without further elaboration, it is believed that one skilled in the art using the preceding description can utilize the present disclosure to its fullest extent. The following Examples are, therefore, to be construed as merely illustrative, and not limiting of the disclosure in any way whatsoever.

### Example 1. Shared Architecture

Multimodal test cards in accordance with the present disclosure have a shared architecture and have interchangeable testing modes. They are highly customizable and readily adapted to address a wide variety of diagnostic problems. The shared architecture provides a uniform base to ensure consistent measurements.

The shared architecture is shown in FIGS. 22-29 and 31 in various expanded and assembled forms. General descriptions of the common components and their functions are in Table 1. The components are listed from top to bottom. Other components may be included in the chips in addition to these components.

TABLE 1
Shared architecture for multimodal test cards.

| Component | Purpose/Function |
|---|---|
| Cover Layer | Provides an air-tight seal at the test card fluid outlet. This prevents fluid from |
| | entering the microchannels upon loading the sample into the loading port. It is |
| | pierced upon loading into the device to allow for pneumatic actuation of fluids |
| | into the test card. |
| Carrier | Interfaces the microfluidic chip to the user (e.g. loading port) and to the device |
| | (e.g. pneumatic and/or electric connection). It may also have cavities and/or |
| | extra ports to process liquid and/or solid phase reagents. It also has fluid capture |
| | chambers under the cover layer to prevent fluid from entering the device. |
| Adhesive Layer | Attaches the chip sub-assembly to the carrier to form the final test card assembly. |
| Channel Mask | Restricts the view of the vision system to just the reaction zones on the test card. |
| Seal Layer | The upper layer of the 3-layer microfluidic chip. It seals the channels and |
| | provides inlet/outlet ports. |
| Channel Layer | The center layer of the microfluidic chip. It provides the main fluidic pathways. |
| Base Layer | The bottom layer of the microfluidic chip. It may be used as a substrate for |
| | additional components (e.g., strip, pads, etc.) |
| Conductive | Main electrical pathways. Analogous to circuit traces on a PCB. |
| circuitry (e.g. | |
| silver traces) | |
| Heaters | Shaped, resistive heaters that provide heat to each reaction/processing zone. |
| Dielectric | Provides electrical and environmental protection. Also provides a controlled |
| component (e.g. | emissivity surface for taking IR temperature measurements. |
| dielectric tape) | |
| Loading Port Cap | Retains the sample and/or reagent mixture in the loading port. |

### Example 2. Interchangeable Testing Modes

Multimodal test cards in accordance with the present disclosure are capable of implementing a variety of tests. A critical benefit to the present disclosure is the interchangeable testing modes. As such, any useful combination of individual tests is within the scope of the present disclosure.

General examples of combinable tests are in Table 2. Other diagnostic tests known in the art are similarly useful. Each column contains sample tests that can be run in combination with any number of tests in any other column. Example combinations are determined by selecting a single test from each column for all columns. Table 1 exemplifies the combination of between two and six different testing modalities, although combinations of testing modalities have greater numbers of different modalities are possible.

TABLE 2
Example interchangeable tests for multimodal test cards.

| Test 1 | Test 2 | Test 3 | Test 4 | Test 5 | Test 6 |
|---|---|---|---|---|---|
| NAAT | NAAT | None | None | None | None |
| LFA | LFA | NAAT | NAAT | NAAT | NAAT |
| Assay | Assay | LFA | LFA | LFA | LFA |
| Antibody | Antibody | Assay | Assay | Assay | Assay |
| Colorimetric | Colorimetric | Antibody | Antibody | Antibody | Antibody |
| Turbidity | Turbidity | Colorimetric | Colorimetric | Colorimetric | Colorimetric |
| Viscosity | Viscosity | Turbidity | Turbidity | Turbidity | Turbidity |
| Light | Light | Viscosity | Viscosity | Viscosity | Viscosity |
| scattering | scattering | | | | |
| Cytometry | Cytometry | Light | Light | Light | Light |
| | | scattering | scattering | scattering | scattering |
| Chemistry | Chemistry | Cytometry | Cytometry | Cytometry | Cytometry |
| — | — | Chemistry | Chemistry | Chemistry | Chemistry |

Specific examples of combinable tests for the multimodal test cards in accordance with the present disclosure are found at least in FIGS. 2-6 and 10-21. These examples are only illustrative of the countless combinations and variations for testing presented by the test card, and do not limit the scope of the disclosure.

The following examples demonstrate individual tests that can be implemented on the test card in various combinations.

### Example 3. PCR Testing Mode

The PCR test mode utilizes the test card as a thermal cycler. The system uses a direct PCR, such that there is minimal to no sample preparation required prior to thermal cycling.

A PCR test is performed with the test card according to the follow method. There are separate method steps for a user and for the automatic test.

Order of operations for a user.

First, a sample is collected. Sample collection varies between assays and sample types. For example, for COVID-19, a nasopharyngeal swab is obtained and then stored in a universal transport media (UTM). Second, the sample mixture, optionally mixed with a UTM or other mixture components, is placed into a tube holding a PCR reagent mixture. Third, the sample-reagent mixture is loaded into the test card loading port via pipette. Fourth, the loading port is covered with the test card loading port cover. Fifth, the test card is placed into a testing device. Sixth, software is used with the testing device to start the test.

Order of operations for the automatic test.

First, the testing device pierces the cover layer with needles. Second, the testing device pulls a vacuum through these needles to pneumatically pull fluid from the loading port into the microfluidic chip. Third, fluid is pulled into the fluid capture chambers located on the underside of the carrier near the cover layer. The pumps are actuated for a prescribed time. Fourth, software checks the condition and location of each reaction zone. Fifth, PCR temperature cycling commences. After a time, the PCR amplification cycles are completed. An image of the reaction zones is taken during each PCR cycle and saved for processing after test is complete. During image acquisition, the testing device properly excites the fluorescent particles in the PCR reaction and filters the light prior to reaching the camera. Sixth, the data are post-processed after PCR cycling is complete. Images for each PCR cycle are analyzed onboard the testing device for reaction fluorescence response. The test determination is made by the software from this analysis.

### Example 4. Lyophilized Pellets Configuration

Addition of the lyophilized pellets allows for an easier workflow, room temperature storage conditions, and multiplexed PCR with one loading port.

A PCR test is performed with the test card according to the follow method. There are separate method steps for a user and for the automatic test.

Order of operations for a user.

First, a sample is collected. Sample collection varies between assays and sample types. For example, for COVID-19, a nasopharyngeal swab is obtained and then stored in a universal transport media (UTM). Second, the sample, optionally mixed with a UTM or other mixture components, is loaded into the test card loading port via pipette. Once in the loading port, the fluid flows using capillary action into the rehydration ports. Third, the loading port is covered with the test card loading port cover. Fourth, the test card is placed into a testing device. Fifth, software is used with the testing device to start the test.

Order of operations for the automatic test.

The order of operations is very similar to that of Example 3, except for differences needed for rehydrating the lyophilized pellet. These differences occur only at the beginning of the order of operations.

The differences include the following. First, heat is applied to the region containing lyophilized pellets for a prescribed amount of time (e.g., 5 min). Air generated during the rehydration process escapes through the pellet air vents located in the carrier. Air movement and heat help ensure a proper mixing of the lyophilized reagents with the liquid phase. Second, the testing device pierces the cover layer with needles. Third, the testing device pulls a vacuum to pneumatically pull fluid through the microfluidic chip to the fluid capture ports.

All other steps after this are the same as in Example 3.

### Example 5. LFA Testing Mode

The test card provides sample input ports, a results viewing window, a means to hold an LFA strip in place, and regulates flow by applying pressure at certain points of the strip.

Order of operations for a user.

First, a sample is collected. Sample collection varies between assays and sample types. For example, a blood sample may be collected. Second, the sample is loaded into the test card loading port via pipette. Third, the test card is placed into a testing device. Fourth, software is used with the testing device to start the test.

Order of operations for the automatic test.

For LFA, the sample is driven by capillary forces through a paper-based LFA strip and is regulated by the test card assembly. Pumps are not required. The testing device primarily acts as a fluorescence reader for determining the presence or absence of test and control lines located on the LFA strip, to which analytes and fluorescent tags bind. The strength of the fluorescence of these lines can also be determined, allowing for a quantitative assay result.

The general order of operations includes the following. First, the fluorescent tags in the LFA strip are excited with filtered light. Second, an image of the LFA test and control line regions is captured. This light is filtered prior to reaching the image sensor. Third, the software onboard the testing device analyzes the images to determine the test result.

### Example 6. Chemistry Testing Mode

The test card is configured to perform a urinalysis. A urinalysis test is a semi-quantitative test for concentrations of analytes in urine. Typically 11 to 13 parameters or analytes are tested through chemical reactions with specific reagents. On a dipstick, the change of color post-reaction is evaluated to estimate the concentration of the analytes.

Order of operations for a user.

First, a sample is collected. Sample collection varies between assays and sample types. For example, a urine sample may be collected. Second, the sample is optionally loaded into the test card loading port via pipette. The sample loading can occur without a pipette. Third, the test card is placed into a testing device. Fourth, software is used with the testing device to start the test.

Order of operations for the automatic test.

For urinalysis, the sample is driven by capillary forces through the microfluidic channels towards the site of reaction for testing. These could be pads within the chip containing the appropriate reagents.

First, the testing device pierces the cover layer with needles. Second, the testing device pulls a vacuum to pneumatically pull fluid from the loading port into the microfluidic chip. Third, images of the different pads after set sitting times are captured. Each parameter requires a specific interaction/sitting time with the sample (e.g., 30 second to 2 minutes). Fourth, the software onboard the testing device analyzes the images to determine the test result.

### Example 7. Cytometry Testing Mode

The test card is configured to perform a cytometry test. A cytometry test is used to identify and count specific cells (typically red blood cells and white blood cells). The cell distribution is quantified using fluorescence. The diluted blood sample is spread inside a microfluidic channel that is wide but short in height. This way, the cells are all contained in one focal plane for imaging. The device is used as an image cytometer in this case.

Order of operations for a user.

First, a sample is collected. Sample collection varies between assays and sample types. For example, a blood sample may be collected. Second, the sample is diluted with a buffer. Third, the sample is loaded into the test card loading port via pipette. Fourth, the test card is placed into a testing device. Fifth, software is used with the testing device to start the test.

Order of operations for the automatic test.

First, the testing device pierces the cover layer with needles. Second, the testing device pulls a vacuum to pneumatically pull fluid from the loading port into the microfluidic chip. Third, images of the cytometry well is captured. Fourth, the software onboard the testing device analyzes the images to determine the test result.

### Example 8. Immunoassay Testing Mode

The test card is configured to perform an immunoassay test. An immunoassay test is used to detect the presence of specific proteins. These proteins are labelled with a fluorescent probe for detection. A polymeric disc coated with antibodies is located inside the microfluidic channel.

Order of operations for a user.

First, a sample is collected. Second, the sample is optionally mixed with an immunoassay mix. The immunoassay mix can alternatively be located within the test card as a lyophilized pellet. Third, the sample is loaded into the test card loading port via pipette. Fourth, the test card is placed into a testing device. Fifth, software is used with the testing device to start the test.

Order of operations for the automatic test.

The testing device acts as a fluorescence reader for determining the presence or absence of proteins.

First, the testing device pierces the cover layer with needles. Second, the testing device pulls a vacuum to pneumatically pull fluid from the loading port into the microfluidic chip. Third, the fluorescent tags on the immunoassay disc are excited. Fourth, images of the immunoassay discs are captured. This light is filtered prior to reaching the image sensor. Fifth, the software onboard the testing device analyzes the images to determine the test result.

### Example 9. Sample Testing Modes

Multimodal test cards in accordance with the present disclosure are capable of implementing a variety of tests. As such, the implemented tests may be selected depending on the specific specimen, modality, and/or detection method of interest. For example, blood can be used as a specimen in various test modes. A NAAT modality may require a fluorescence detection method or an electrical potential detection, depending on which NAAT assay is chosen.

Generally, any reaction resulting in a change of an optical or electrical measurement may be used with the test card to detect the presence and/or amount of an analyte (e.g. molecule, pathogen) and could be designed for implementation in the multimodal testing system according to the present disclosure.

Table 3 lists possible combinations of multimode test cards with respect to sample type, test type, and detection method. Each column is independent and represents the possible specimens, modalities, optical detection methods, and electrical detection methods, respectively, that may be used in accordance with the present disclosure. The rows of each column may be combined in any order for any particular design of the test card. For example, one embodiment of a test card may be configured to use a fluorescence detection method for a NAAT modality to analyze a sputum specimen. As another example, one embodiment of a test card may be configured to use an ion selective electrode detection method for a clinical chemistry test modality to analyze a urine specimen. These combinations exemplify the interchangeability of the test card in accordance with the present disclosure.

TABLE 3
Select interchangeable tests for multimodal test cards.

| | | | Electrical |
|---|---|---|---|
| | | Optical Detection | Detection |
| Specimen | Modality | Method | Method |
| Blood | NAAT | Fluorescence | Impedance |
| Urine | Immunoassay | Colorimetric/Absorbance | Piezoelectric |
| Sputum | Clinical | Light scattering | Ion selective |
| | chemistry test | | electrode |
| Saliva | Cytometry | Chemiluminescence | Electrical |
| | | | potential |
| Oral fluid | Physical | Electroluminescence | Electrical |
| | properties | | current |
| | (viscosity, | | |
| | turbidity) | | |
| Stool | | Fluid presence, position, | |
| | | or velocity | |
| Semen | | | |
| Other bodily | | | |
| fluid | | | |
| Environmental | | | |

### Example 10. SARS-COV-2 Virus Detection and IgG/IgM Detection Test Card

A test card for SARS-COV-2 virus detection and IgG/IgM detection may include two test modes. The two test modes are, for example, a single target NAAT and LFA Immunoassay for detecting the virus and IgM/IgG antibodies, respectively. For this case, fluorescence is chosen as the detection method for both modes. The sample types are a nasopharyngeal swab in a suspension buffer and whole blood for the NAAT and LFA modes, respectively. Because of differing sample types between modes, two loading ports are needed. Both samples in this case are liquid-phase, thus there is no on-card sample processing or rehydration. The resulting architecture is shown in FIG. 2.

For the NAAT, heaters at each PCR well are needed and pneumatic ports for controlling fluid flow within the chip. For LFA, features on the chip and carrier are required for locating, clamping, and controlling flow.

### Example 11. Method of Manufacture for a Single Carrier and Single Chip

This method of manufacture is shown in FIGS. 23 and 27. The individual aspects of the exploded view are combined in order. Features for locating, clamping, and controlling flow of the LFA strip are split between the carrier and the chip.

### Example 12. Method of Manufacture for a Multi-Part Carrier and Single Chip

The product of this method of manufacture is shown in FIG. 30. The individual aspects of the exploded view are combined in order. Features for locating, clamping, and controlling flow on an LFA strip are located only on the carrier. To do so, the carrier is split into two components. The microfluidic chip only houses features for the test mode, such as NAAT. This method of manufacture has the benefit of isolating features for test modes into separate components, thereby further modularizing the system. However, higher part counts are needed for the assembly.

### Example 13. Method of Manufacture for a Single Carrier and Multiple Chips

This method of manufacture is shown in FIG. 31. This method of manufacture is similar to that of Example 11, however, the test card includes two half-sized chips. Each chip contains functions for only that modality. The first modality chip, such as an NAAT chip, contains the microfluidics and other features needed for that mode. The second modality chip, such as an LFA chip, only contains features related to the second modality. When the second modality is LFA, the chip includes a thin piece of plastic with locating and clamping features as the microfluidic configuration.

Features for locating, clamping, and controlling flow on an LFA strip are located only on the carrier. To do so, the carrier is split into two components. The microfluidic chip only houses features for the test mode, such as NAAT. This method of manufacture has the benefit of isolating features for test modes into separate components, thereby further modularizing the system. However, higher part counts are needed for the assembly.

This written description uses examples to illustrate the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As used herein, a “testing mode” means a unique type of physical, chemical, or biological test.

As used herein, “microfluidic” means that one of the characteristic length scales, e.g., the height or width of a fluid system, features dimensions in the micrometer range or below.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A microfluidic chip comprising:
at least one input port fluidically connected to at least two test zones by at least one microfluidic guide;
wherein the at least two test zones are configured to perform at least two different tests.

2. The microfluidic chip of claim 1, further comprising a component selected from the group consisting of an additional input port, a microchannel, a sample processing port, a rehydration port, a test zone, and combinations thereof.

3. The microfluidic chip of claim 2, wherein the sample processing port is positioned in a microchannel upstream from a test zone.

4. The microfluidic chip of claim 1, wherein at least two of the at least two test zones are not fluidically connected.

5. The microfluidic chip of claim 1, wherein at least two of the at least two test zones are fluidically connected.

6. The microfluidic chip of claim 1, wherein the microfluidic chip comprises at least three test zones.

7. The microfluidic chip of claim 1, wherein the microfluidic chip comprises at least two polymeric layers.

8. The microfluidic chip of claim 1, wherein the microfluidic chip comprises a single polymeric layer.

9. The microfluidic chip of claim 1, wherein the at least two test zones comprises at least two test zones configured to perform different testing modes.

10. The microfluidic chip of claim 1, comprising at least two input ports.

11. The microfluidic chip of claim 10, wherein each input port is fluidically connected to a separate test zone.

12. The microfluidic chip of claim 10, wherein each input port is fluidically connected to at least two test zones configured to perform the same testing mode.

13. The microfluidic chip of claim 1, wherein each test zone in the at least two test zones is individually configured to perform a test selected from the group consisting of a nucleic acid amplification test (NAAT), a polymerase chain reaction (PCR) test, a reverse-transcription polymerase chain reaction (RT-PCR) test, an isothermal amplification test, a loop mediated isothermal amplification (LAMP) test, an antigen test, an assay test, a lateral flow assay test, an enzyme-linked immunosorbent assay test, an antibody test, a colorimetric test, a turbidity test, a viscosity test, a light scattering test, a cytometry test, an ion selectivity test, and combinations thereof.

14. A test card comprising:
a microfluidic chip comprising:
at least one input port fluidically connected to at least two test zones by at least one microfluidic guide;
wherein the at least two test zones are configured to perform at least two different tests; and
a chip carrier coupled to the microfluidic chip.

15. The test card of claim 14, wherein the chip carrier comprises a heater positioned underneath a component of the microfluidic chip selected from the group consisting of an input port, a sample processing port, a rehydration port, a test zone, and combinations thereof.

16. The test card of claim 14, wherein the chip carrier is coupled to the microfluidic chip with a coupling mechanism selected from the group consisting of mechanical couplings, chemical couplings, adhesives, a welding, an ultrasonic welding, a laser welding, a melt welding, and combinations thereof.

17. A method of using a test card comprising:
receiving, using a test card, a sample from a subject, the test card including a chip carrier coupled to a microfluidic chip, the microfluidic chip including: at least one input port fluidically connected to at least two test zones by at least one microfluidic guide, wherein the at least two test zones are configured to perform at least two different tests; and
testing the sample using the at least two test zones of the test card.

18. The method of claim 17, wherein the sample is selected from the group consisting of unprocessed biological fluids, processed biological fluids, blood, serum, plasma, urine, feces, saliva, tears, sweat, semen, sputum, lysed tissue, and combinations thereof.

19. The method of claim 17, wherein the test card tests the sample for an infectious agent selected from the group consisting of bacterial pathogens, viral pathogens, fungal pathogens, parasitic pathogens, and combinations thereof.

20. The method of claim 17, wherein each test zone in the at least two test zones individually performs a test selected from the group consisting of a nucleic acid amplification test (NAAT), a polymerase chain reaction (PCR) test, a reverse-transcription polymerase chain reaction (RT-PCR) test, an isothermal amplification test, a loop mediated isothermal amplification (LAMP) test, an antigen test, an assay test, a chemistry test, an immunochemistry test, a lateral flow assay test, an enzyme-linked immunosorbent assay test, an antibody test, a colorimetric test, a turbidity test, a viscosity test, a light scattering test, a cytometry test, an ion selectivity test, and combinations thereof.
